(19) United States
(12) Patent Application Publication
(10) Pub. No.: US 2017/0063875 A1
(43) Pub. Date: Mar. 2, 2017

(54) INFORMATION PROCESSING SYSTEM AND INFORMATION PROCESSING APPARATUS

(71) Applicant: Masatoshi YANASE, Kanagawa (JP)

(72) Inventor: Masatoshi YANASE, Kanagawa (JP)

(73) Assignee: Ricoh Company, Ltd., Tokyo (JP)

(21) Appl. No.: 15/251,096

(22) Filed: Aug. 30, 2016

(30) Foreign Application Priority Data
Sep. 2, 2015 (JP) 2015-173320

(51) Int. Cl. H04L 29/06; H04W 12/06

(52) U.S. Cl. CPC H04L 63/105; H04L 63/083; H04W 12/06; H04L 63/0876

(57) ABSTRACT

An information processing system includes a login authentication processing unit and a display control unit. The login authentication processing unit is configured to, when first authority information for a login is input, perform authentication on the first authority information and performs a login process, and when second authority information for a login is input, perform authentication on the second authority information and performs a login process. The display control unit is configured to, when there is no difference between the first and the second authority information, cause a first display unit and a second display unit to display common display information, and when there is the difference, cause a first display unit to display display information and causes the second display unit to restrict displaying of content of the display information.

### CROSS-REFERENCE TO RELATED APPLICATION

The present application claims priority under 35 U.S.C. §119 to Japanese Patent Application No. 2015-173320, filed Sep. 2, 2015. The contents of which are incorporated herein by reference in their entirety.

### BACKGROUND OF THE INVENTION

1. Field of the Invention

The present invention relates generally to an information processing system and an information processing apparatus.

2. Description of the Related Art

A remote support technology is already known in which, when a user of a multifunction peripheral (MFP) does know now how to operate the MFP, a support person supports the user in operating the MFP performing remote operations from a remote operation terminal, such as a PC.

In this technology, the support person connects the remote operation terminal to the MFP of the user and remotely operates the MFP from the remote operation terminal according to an inquiry by using a telephone from the user. The operation screen of the MFP is displayed on the screen of the remote operation terminal and, when the support person operates the screen on the remote operation terminal, that operation is displayed also on the screen of the MFP. Accordingly, the user can have an explanation from the support person while watching the actual operation on the screen of the MFP.

In the conventional remote support technology, to remotely operate the MFP from the remote operation terminal, first of all, the supporting staff operates the MFP according to the authority of “normal user” that is used by the user who is given a support to log in the MFP; however, depending on the setting or the content of support, authority of “apparatus manager” is necessary. In that case, there is a problem that, if the support person changes the authority with respect to the MFP from that of “normal user” to different authority, such as the authority of “apparatus manager”, a screen that can be viewed by only the apparatus manager would be displayed to the user who does not have t authority to view the screen.

### SUMMARY OF THE INVENTION

According to one aspect of the present invention, an information processing system includes a first input unit for inputting first information, a second input unit for inputting second information, a first display unit, a second display unit, a login authentication processing unit, a determining unit, and a display control unit. The login authentication processing unit is configured to, when first authority information for a login is input from the first input unit as the first information, perform authentication on the first authority information and performs a login process, and when second authority information for a login is input from the second input unit as the second information, perform authentication on the second authority information and performs a login process. The determining unit is configured to, when the first information is input from the first input unit, determine whether there is a difference between the first authority information and the second authority information on which authentication has been performed by the login authentication processing unit on the login process. The display control unit is configured to, when the determining unit determines that there is no difference between the first authority information and the second authority information, cause the first display unit and the second display unit to display common display information, and when the determining unit determines that there is the difference, cause the first display unit to display display information and causes the second display unit to restrict displaying of content of the display information.

### BRIEF DESCRIPTION OF THE DRAWINGS

FIG. 1 is an overview illustrating an image processing system of a first embodiment of the present invention;

FIG. 2 is a diagram of an exemplary system configuration of the image processing system;

FIG. 3 is a diagram of an exemplary hardware configuration of a PC;

FIG. 4 is a diagram of an exemplary hardware configuration of an image processing apparatus;

FIG. 5 is a functional block diagram of an exemplary function of the image processing system corresponding to a remote operation;

FIG. 6 is a diagram of exemplary display permissibility determination information;

FIG. 7 is a diagram of exemplary authentication information that is stored by a second storage unit;

FIG. 8 is a sequence chart of an exemplary operation in the image processing system performed when a PC remotely connects to the image processing apparatus;

FIG. 9 is a sequence chart of an exemplary operation in the image processing system performed when the PC changes the authority and then logs in the image processing apparatus;

FIG. 10 is a sequence chart of an exemplary flow of a process of generating screen information for the image processing apparatus that is performed by the image processing apparatus;

FIG. 11 is a diagram of exemplary displays of the display screen of the PC and the display screen of the image processing apparatus, which are displayed when the display screen generator performs a display restriction process;

FIG. 12 is a diagram of an exemplary functional block of a PC and an image processing apparatus of an information processing system of a second embodiment of the present invention;

FIG. 13 is a sequence chart of an exemplary operation in an image processing system performed when a PC changes the authority and then logs in the image processing apparatus again;

FIG. 14 is a sequence chart of an exemplary flow of a display permissibility determination process performed by the PC;

FIG. 15 is a diagram of exemplary displays of the display screens of the PC and the image processing apparatus after a display restriction process for causing display not to be displayed or to be in a state equivalent to the state of not being displayed in a third embodiment of the present invention;

FIG. 16 is a diagram of exemplary displays of display screens of a PC and an image processing apparatus of a fourth embodiment of the present invention;

FIG. 17 is a diagram of exemplary displays of the display screen of an image processing apparatus of a fifth embodiment of the present invention, containing message information representing a reason for restricting the display;

FIG. 18 is a diagram of an exemplary functional block of a PC of a sixth embodiment of the present invention;

FIG. 19 is a diagram of an exemplary setting screen;

FIG. 20 is a diagram of an exemplary functional block of an image processing system of a seventh embodiment of the present invention;

FIG. 21 is a diagram of an exemplary check screen;

FIG. 22 is a diagram of an exemplary functional block of an information processing system of an eighth embodiment of the present invention;

FIG. 23 is a diagram of an exemplary screen transition of a display screen of an information processing apparatus displayed when an error occurs in a communication with a PC;

FIG. 24 is a diagram of an exemplary functional block of an image processing system of a ninth embodiment of the present invention;

FIG. 25 is a diagram illustrating part of a setting in a second storage unit; and

FIG. 26 is a diagram of an exemplary screen transition of a display screen of an image processing apparatus occurring when an error in a communicating with a PC occurs.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an information processing system and an information processing apparatus that make it possible to, even when a support staff changes the authority of a user to different authority while remotely operating an information processing apparatus, such as a MFP, prevent information that the user does not have authority to view from being viewed on the screen of the information processing apparatus.

An information processing system, an information processing apparatus, and a program will be described in detail below with reference to the accompanying drawings. An example where the information processing system is applied to an image processing system will be described as an example.

### First Embodiment

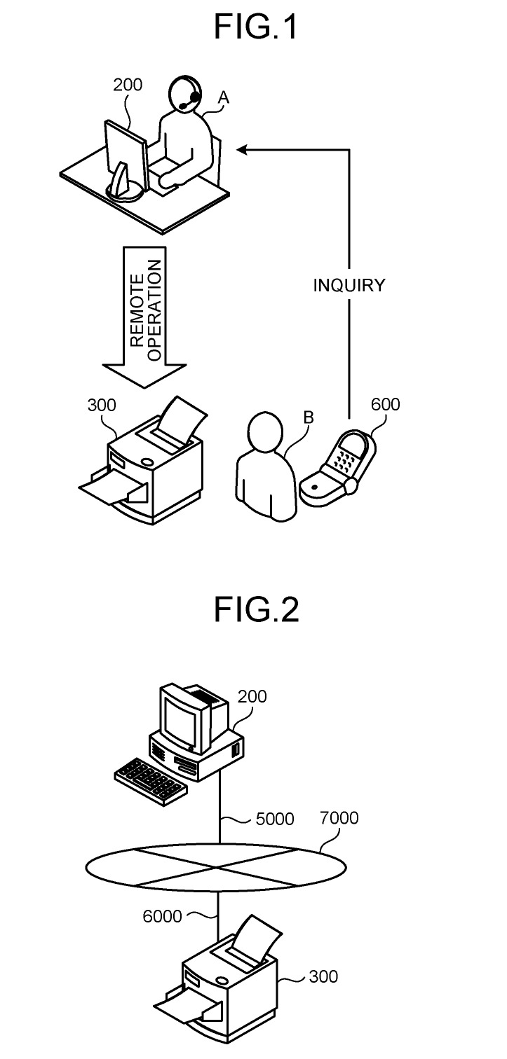

FIG. 1 is an overview illustrating an image processing system according to a first embodiment of the present invention. The image processing system according to the first embodiment includes a personal computer (PC) 200 and an image processing apparatus 300 that are illustrated in FIG. 1. The PC 200 is a remote operation terminal for remotely operating the image processing apparatus 300 and is set in, for example, a support center. A support person A who provides a support service with respect to the image processing apparatus 300 operates the PC 200. The support person A connects the PC 200 to the image processing apparatus 300 via a network, such as a local area network (LAN) or the Internet, and remotely operates the image processing apparatus 300 on the PC 200. The image processing apparatus 300 is any image processing apparatus, such as a multifunction peripheral (MFP), that is set in, for example, a company or a shop. A user B operates the image processing apparatus 300.

An exemplary case where the support person A performs a remote operation will be described here. The user B is given authority of “normal user” and, when using the image processing apparatus 300, uses the authority of “normal user” to log in the image processing apparatus 300. After the login, the user B makes settings for various functions (including a function of a print output process) of the image processing apparatus 300 and issues instructions to implement the functions while checking the screen of the operation panel of the image processing apparatus 300. When, for example, the user B does not know how to operate the image processing apparatus 300 during the operation, the user B makes an inquiry to, for example, a support center with, for example, a mobile phone 600 illustrated in FIG. 1. The inquiry is made by, for example, voice communications. The support person A remotely connects the PC 200 to the image processing apparatus 300 according to this inquiry. Then, while remotely operating the image processing apparatus 300 on the PC 200, the support person A explains the procedure of operating the image processing apparatus 300 by voice to the mobile phone 600 of the user B. The user B hears an explanation on the operation procedure from the support person A on the mobile phone 600 while checking the screen of the operation panel that is switched by the remote operation performed by the support person A.

FIG. 2 is a diagram of an exemplary system configuration of the image processing system illustrated in FIG. 1. The PC 200 and the image processing apparatus 300 that are illustrated in FIG. 2 are provided in the support center and a company respectively in different LANs (a LAN 5000 and a LAN 6000). Each of the LAN 5000 and the LAN 6000 is configured to be connectable to the Internet 7000. The LAN 5000 and the LAN 6000 may be connected by, for example, a virtual private network (VPN). The PC 200 and the image processing apparatus 300 have network addresses, respectively, and communicate with each other by using the respective network addresses via each communication line. With respect to the first embodiment, as an example of the image processing apparatus 300, one in which an information processing terminal having a computer configuration is applied to an operation unit will be described.

The hardware configuration of each unit will be described here.

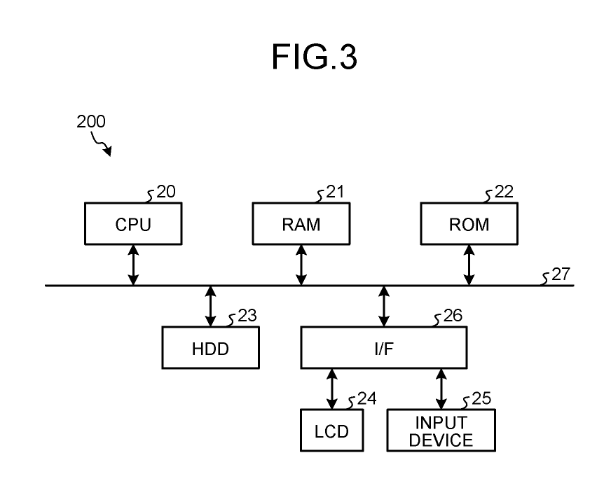

FIG. 3 is a diagram of an exemplary hardware configuration of the PC 200. As illustrated in FIG. 3, the PC 200 includes a CPU 20, a RAM 21, a ROM 22, a HDD 23, and an interface (I/F) 26. The units are connected with one another via a bus 27. The PC 200 further includes a LCD 24 and an input device 25 that are connected to the bus 27 via the interface (I/F) 26.

The CPU 20 is a central processing unit and controls entire operations of the PC 200. The RAM 21 is a volatile storage medium enabling high-speed read/write of information. The RAM 21 is used as a work area for the CPU 20 to process information. The ROM 22 is a read-only non-volatile storage medium in which programs, such as firmware, are stored. The HDD 23 is a storage medium, such as a magnetic storage medium enabling read/write of information, in which an operating system (OS) and various control programs, and applications programs, etc., are stored. In the following descriptions, a “first storage unit” is used as appropriate as a word generally referring to storage units of the PC 200, including the RAM 21, the ROM 22 and the HDD 23.

The interface (I/F) 26 is an interface circuit that performs processing for input/output between the CPU 20, the RAM 21, the ROM 22, the HDD 23, etc., with an external device. The interface (I/F) 26 includes a communication processing unit for communicating with the image processing apparatus 300 via, for example, the LAN 5000. The interface (I/F) 26 further includes an output processing unit for outputting information on pixels configuring a screen to the LCD 24. The interface (I/F) 26 further includes an input processing unit that converts an input signal from the input device 25 into given information and outputs the information the CPU 20.

The LCD 24 is a display device, such as a liquid crystal display panel, for displaying various screens, such as an operation screen. The input device 25 is an input device, such as a keyboard and a mouse, for a user to input information to the PC 200. A touch panel may be used as the input device 25 and the touch panel may be provided integrally with the display panel of the LCD 24.

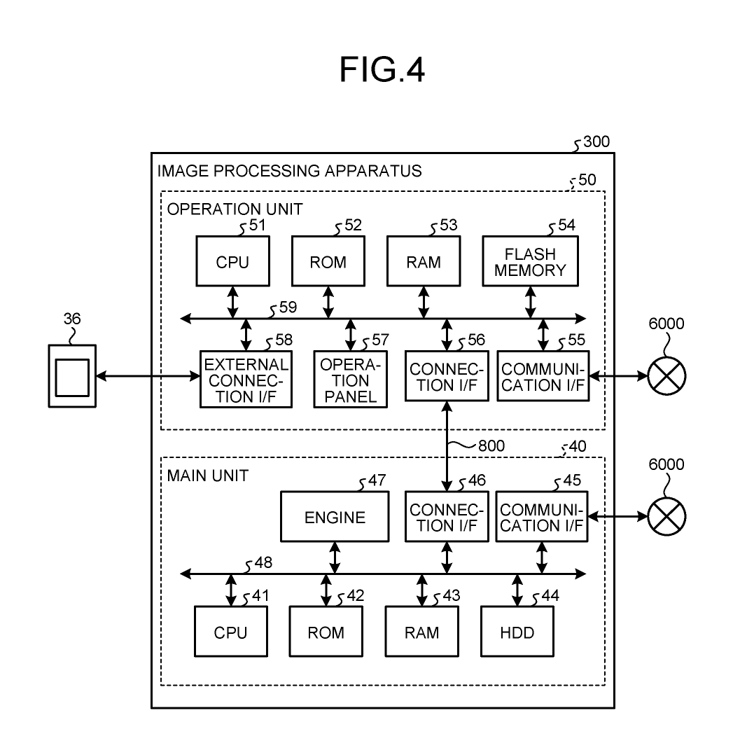

FIG. 4 is a diagram of an exemplary hardware configuration of the image processing apparatus 300. As shows in FIG. 4, the image processing apparatus 300 includes a main unit 40 and an operation unit 50 and they perform operations as an information processing apparatus as a whole. The main unit 40 has a hardware configuration for performing image processing mainly for a copy process, a scanning process, a facsimile transmission process, a print output process and part of a process corresponding to a remote operation. The operation unit 50 has a hardware configuration for a process of, for example, accepting an operation from the user B (see FIG. 1) and displaying an operation screen to the user B, mainly for talking to the user B. The hardware configuration of the operation unit 50 will be described by using the hardware configuration of the information processing terminal here as an example.

The hardware configuration of the main unit 40 will be described here. As illustrated in FIG. 4, the main unit 40 includes a CPU 41, a ROM 42, a RAM 43, a HDD 44, a communication I/F 45, a connection I/F 46, and an engine unit 47 that are connected with one another via a bus 48.

The CPU 41 is a central processing unit and controls entire operations of the main unit 40. The RAM 43 is a volatile storage medium enabling high-speed read/write of information. The RAM 43 is used as a work area for the CPU 41 to process information. The ROM 42 is a read-only non-volatile storage medium in which programs, such as firmware, are stored. The HDD 44 is a storage medium, such as an information readable magnetic storage medium, in which an OS and various control programs and application programs are stored. In the following descriptions, a “second storage unit” is used as a word generally referring to the storage units of the main unit 40, such as the ROM 42, the RAM 43, and the HDD 44.

The communication I/F 45 is a communication interface for connection to the LAN 6000.

The connection I/F 46 is a communication interface for performing communications with a connection I/F 56 of the operation unit 50 via a communication path 800. A communication system according to any standard may be used for the connection I/F 46 and the connection I/F 56 of the operation unit 50. For example, one according to the universal serial bus (USB) standard may be used. Alternatively, the communication path 800 may be configured to be wired or may be configured to be wireless.

The engine unit 47 may include a dedicated LSI (for example, an ASIC) for executing the copy process, the scanning process, the facsimile transmission process, and the print output process and a drive unit. The engine unit 47 may include a paper conveyance unit as the drive unit.

The hardware configuration of the operation unit 50 will be described here. As illustrated in FIG. 4, the operation unit 50 includes a CPU 51, a ROM 52, a RAM 53, a flash memory 54, a communication I/F 55, the connection I/F 56, an operation panel 57, and an external connection I/F 58 that are connected with one another via a bus 59.

The CPU 51 is a central processing unit that controls entire operations of the operation unit 50. The RAM 53 is a volatile storage medium enabling high-speed read/write of information. The RAM 53 is used as a work area for the CPU 51 to process information. The ROM 52 is a read-only non-volatile storage medium in which programs, such as firmware, are stored. The flash memory 54 is a non-volatile storage medium enabling read/write of information in which an OS and various control programs and application programs are stored.

The communication I/F 55 is a communication interface for connection to the LAN 6000.

The connection I/F 56 is a communication interface for communicating with the connection I/F 46 of the main unit 40 via the communication path 800.

The operation panel 57 is a display device employing a touch input system obtained by providing a touch panel integrally with the display panel, such as a liquid crystal display panel. An organic EL display device may be used instead of the liquid crystal display panel. Instead of the touch panel, hardware keys serving as a user interface may be provided. Furthermore, for example, hardware keys and an LED lamp may be provided additionally. The operation panel 57 generates various types of operation information according to touch operations performed by the user B on the display panel via the touch panel. The operation panel 57 notifies the CPU 51 of the generated operation information. The operation panel 57 causes the display panel to display the screen that is generated by the CPU 51. The screen displayed on the display panel is an operation screen containing, for example, a login screen, a login change screen, a setting screen, an execution instruction screen, and a message screen.

The external connection I/F 58 is a communication interface for connecting an IC card reader 36. The IC card reader 36 is a device that reads, for example, the identification information from the IC card of the user B for a charge process performed when the user B uses, for example, the copy process.

The functions of the PC 200 and the image processing apparatus 300 will be described here.

Mainly, functions corresponding to a remote operation will be described here.

In the PC 200, the CPU 20, for example, loads a given program that is stored in the ROM 22 or the HDD 23 into the RAM 21 and executes the program to implement a functional unit corresponding to a remote operation. On the other hand, in the image processing apparatus 300, the CPU 41, for example, loads a given program that is stored in the ROM 42 or the HDD 44 into the RAM 43 and executes the program to implement the functional unit corresponding to a remote operation in the main unit 40. Furthermore, the CPU 51, for example, loads a given program that is stored in the ROM 52 or the flash memory 54 into the RAM 53 and executes the program to implement a functional unit mainly corresponding to a user interface in the remote process in the operation unit 50. In the image processing apparatus 300, commands and data are transmitted between the main unit 40 and the operation unit 50 via the communication path 800 (see FIG. 4) unless otherwise denoted.

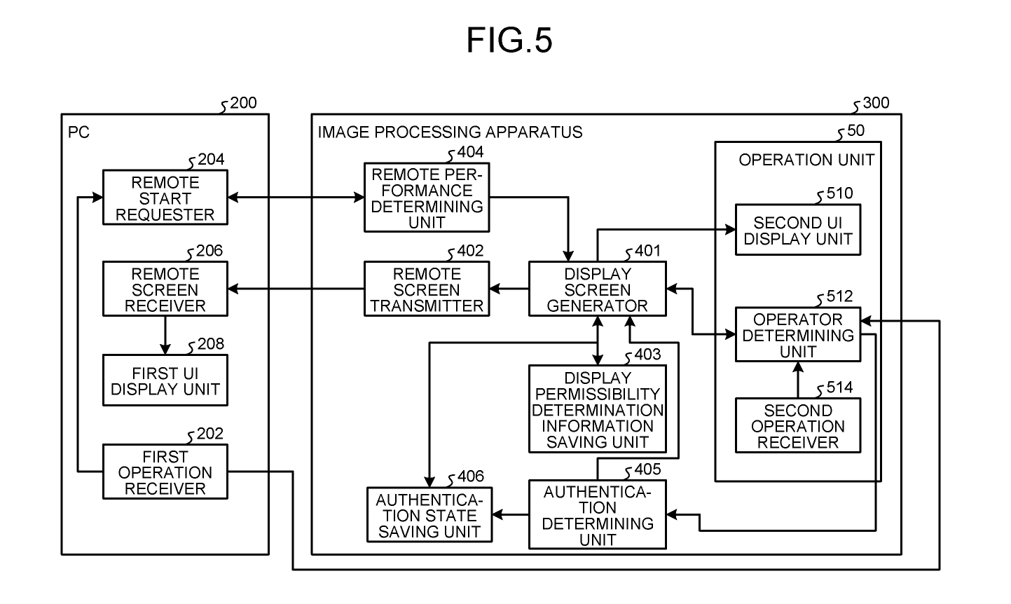

FIG. 5 is a functional block diagram of exemplary functions for remote operations implemented by the PC 200 and the image processing apparatus 300. The functions implemented by the PC 200 will be described first.

The PC 200 implements a first operation receiver 202, a remote start requester 204, a remote screen receiver 206, and a first UI display unit 208 as the functional unit corresponding to the remote operation.

The first operation receiver 202 accepts operation information on an operation that is performed by the support person A (see FIG. 1) from the input device 25 (see FIG. 3). Furthermore, in accordance with the content of the operation information accepted from the support person A, the first operation receiver 202 instructs a processing unit corresponding to the content to perform a process. Specifically, the first operation receiver 202 accepts, as the operation information, various types of commands and input data that are input by the support person A by clicking the mouse or pressing a button. Furthermore, when the accepted operation information is, for example, a command for an instruction for starting a remote connection to the image processing apparatus 300, the first operation receiver 202 instructs the remote start requester 204 to execute the process of a remote connection to the image processing apparatus 300. Assume that the first operation receiver 202 accepts information for remotely operating the image processing apparatus 300 after the remote connection to the image processing apparatus 300 is started. In this case, the first operation receiver 202 generates request data requesting an operator determining unit 512 to execute the process on the operation information, where the specified address of the image processing apparatus 300 is the destination of the request data.

The address is a network address, such as an IP address. The specified address refers to an address that is set with respect to any one of the communication I/F 45 (see FIG. 4) or the communication I/F 55 (see FIG. 4). In the first embodiment, the specified address is of the communication I/F 45. Accordingly, the first operation receiver 202 instructs the communication I/F 45 to transmit the requested data.

The remote start requester 204 performs a remote connection to the image processing apparatus 300. Specifically, the remote start requester 204 generates connection request data requesting a remote performance determining unit 404 to start a remote connection, where the address of a remote connection partner contained in the operation information accepted by the first operation receiver 202 is the destination of the connection request data. The remote start requester 204 then instructs the interface (I/F) 26 (see FIG. 3) to transmit the connection request data.

With respect to the address of the remote connection partner, for example, the support person A specifies the remote connection partner from, for example, a display box displaying a list of remotely connectable terminals and accordingly the first operation receiver 202 incorporates the address of the specified terminal in the operation information. Accordingly, the remote start requester 204 is able to obtain the address of the remote connection partner. In the first embodiment, the address of the main unit 40 of the image processing apparatus 300 is specified as the address of the remote connection partner.

Accordingly, in this case, in accordance with the transmission instruction from the remote start requester 204, the interface (I/F) 26 transmits the connection request data to the communication I/F 45 (see FIG. 4) in the LAN 6000 (see FIG. 2) via the LAN 5000 (see FIG. 2). When the remote performance determining unit 404 of the image processing apparatus 300 sends back response data to the connection request data, the remote start requester 204 receives the response data from the interface (I/F) 26.

Through this procedure, the remote start requester 204 receives the response data representing that “a connection is possible” and starts a remote connection to the image processing apparatus 300.

The remote screen receiver 206 receives screen information that is the source from which the display screen displayed on the image processing apparatus 300 is generated during the remote connection and outputs the screen information to the first UI display unit 208. In the image processing apparatus 300, according to the instruction of a remote screen transmitter 402, the screen information is transmitted from the communication I/F 45 (see FIG. 4) to the interface (I/F) 26 (see FIG. 3). The remote screen receiver 206 receives the screen information from the interface (I/F) 26 and outputs the screen information to the first UI display unit 208.

The screen information refers to information representing the layout and color setting of the display screen, character information, ruled lines, symbols, the background image, and a partial image that serve as display information configuring the display screen, which applies to the following description.

The first UI display unit 208 displays a screen based on the screen information on the LCD 24 (see FIG. 3) of the PC 200. The screen information is, for example, screen information of the PC 200 or screen information that is transmitted from the image processing apparatus 300. In the first embodiment, screen information on a specifying screen on which a terminal that is a remote connection subject from the list of terminal is specified, or on a connection request screen requesting the terminal specified on the specifying screen for a remote connection, is stored in the PC 200 as one type of screen information of the PC 200. When the first operation receiver 202 accepts operation information for calling a screen for a remote connection, the first UI display unit 208 displays the specifying screen or the connection request screen described above on the LCD 24 of the PC 200. The first UI display unit 208 receives the output of the screen information, which is transmitted from the image processing apparatus 300, from the remote screen receiver 206 and accordingly displays the display screen of the image processing apparatus 300 on the LCD 24 of the PC 200. The screen information that is transmitted from the image processing apparatus 300 is, for example, an operation screen containing a login change screen, a setting screen, an execution instruction screen, and a message screen.

The functions implemented by the image processing apparatus 300 will be described here.

The image processing apparatus 300 includes, as functional units corresponding to a remote operation, a second operation receiver 514, the operator determining unit 512, a display screen generator 401, a second UI display unit 510, the remote screen transmitter 402, a display permissibility determination information saving unit 403, the remote performance determining unit 404, an authentication determining unit 405, and an authentication state saving unit 406. The second operation receiver 514, the operator determining unit 512, and the second UI display unit 510 are functional units mainly corresponding to a process of talking to the user B and are implemented by the operation unit 50. The display screen generator 401, the remote screen transmitter 402, the display permissibility determination information saving unit 403, the remote performance determining unit 404, the authentication determining unit 405, and the authentication state saving unit 406 are functional units corresponding to the remote process and are implemented by the main unit 40.

The second operation receiver 514 accepts operation information on an operation that is performed by the user B from the operation panel 57 of the image processing apparatus 300 (see FIG. 4). Specifically, the second operation receiver 514 accepts, as operation information, information representing various commands and input data that are input by the user B by performing an operation of touching the operation panel 57. Furthermore, the second operation receiver 514 instructs the operator determining unit 512 to execute processing on the accepted operation information.

The operator determining unit 512 receives the operation information from the first operation receiver 202 and the operation information from the second operation receiver 514. In the first embodiment, for easy understanding of the descriptions, it is assumed that, after the remote connection from the PC 200 is started, the operator determining unit 512 rejects to receive the operation information from the second operation receiver 514 in response to a start notification from the display screen generator 401.

Upon receiving the operation information from the first operation receiver 202 or the second operation receiver 514, the operator determining unit 512 determines whether the operation source of the operation information is the support person A of the PC 200 or the user B of the image processing apparatus 300. The operator determining unit 512 adds operator information obtained by the determination to the operation information. For example, the operator determining unit 512 determines the operator from the address representing the transmission source and the name of the apparatus that are received together with the operation information. Upon determining that it is an operation performed from the PC 200, the operator determining unit 512 adds information representing that it is a remote operation from the PC 200 as the operator information. On the other hand, upon determining that it is the remote operation performed on the image processing apparatus 300, the operator determining unit 512 adds, as the operator information, information representing that it is an operation on the image processing apparatus 300 own.

The operator determining unit 512 instructs a corresponding processing unit to perform the process according to the content of the operation information. For example, when the operation information corresponds to a screen operation, the operator determining unit 512 instructs the display screen generator 401 to execute the screen generation process. When the operation information contains login information representing a user name and a password, the operator determining unit 512 instructs the authentication determining unit 405 to execute the authentication process. Note that, although it is not illustrated in the drawings, when the operation information accompanies a command for executing the print output process or the facsimile transmission process, the operator determining unit 512 instructs an execution unit (not illustrated) that executes the print output process and the facsimile transmission process to execute the process.

The display screen generator 401 acquires given screen information from the second storage unit of the main unit 40, performs given processing as required on the screen information, and outputs the processed screen information to the remote screen transmitter 402 or the second UI display unit 510.

Specifically, the display screen generator 401 acquires, from the second storage unit of the main unit 40, given screen information on the basis of the operation information that is received from the operator determining unit 512. When the operator information added to the operation information represents the operation on the image processing apparatus 300, the display screen generator 401 outputs the acquired screen information to the second UI display unit 510. On the other hand, when the operator information represents the remote operation from the PC 200, the display screen generator 401 processes the acquired screen information as described in the following example.

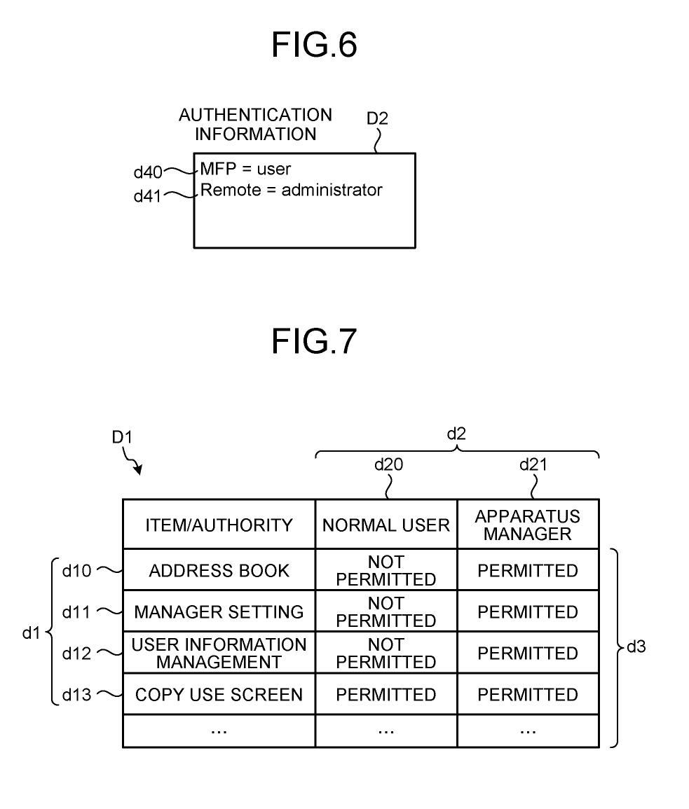

First of all, the display screen generator 401 outputs the acquired screen information to the remote screen transmitter 402. Secondly, from authentication information D2 (see FIG. 6) that is saved by the authentication state saving unit 406 in the second storage unit, the display screen generator 401 checks the difference between the two sets of authority information, which will be described below. The display screen generator 401 then generates screen information according to the difference, and outputs the generated screen information to the second UI display unit 510. One of the two sets of authority information is the authority information that is used by the user B for the latest login in the image processing apparatus 300 (authority information on the image processing apparatus 300). The other is the authority information (authority information on the PC 200) that is used by the support person A during the remote operation in the latest login in the image processing apparatus 300. The data configuration of the authentication information D2 and the flow of the process of saving the authentication information D2 performed by the authentication state saving unit 406 will be described below.

The display screen generator 401 generates screen information to be output to the second UI display unit 510 according to the difference between the two sets of authority information as follows.

First of all, assume that both the sets of authority information on the PC 200 and the image processing apparatus 300 represent a “normal user”. This corresponds to the case where, for example, the user B logs in the image processing apparatus 300 by using the authority of “normal user” and then, on a remote operation, the support person A logs in the image processing apparatus 300 without changing the authority of “normal user” from the PC 200. In this case, the display screen generator 401 outputs a copy of the screen information that is output to the remote screen transmitter 402 to the second UI display unit 510.

Furthermore, assume that the authority information on the PC 200 represents the “apparatus manager” and the authority information on the image processing apparatus 300 represents a “normal user”. This corresponds to the case where, for example, the user B logs in the image processing apparatus 300 by using the authority of “normal user” and then, on a remote operation, the support person A changes the authority to that of “apparatus manager” and logs in the image processing apparatus 300 again. In this case, the display screen generator 401 acquires, from the display permissibility determination information saving unit 403, information (see the display permissibility determination information D1 illustrated in FIG. 7) in which whether display is “permitted” or display is “not permitted” is specified with respect to each display item on “normal user”. According to the item on which display is “permitted” or “not permitted” is specified, the display screen generator 401 performs a display restriction process of, for example, concealing the display information of the corresponding item or information on an area wider than that of the display information of the corresponding item on the copy of the screen information that is output to the remote screen transmitter 402. The “display information” herein refers to characters, ruled lines, and images (such as the background image or a partial image) that are set as the subject to be displayed in the screen information. The display screen generator 401 makes a setting for not displaying the display information on the corresponding item on the copy of the screen information. In another example, the display screen generator 401 sets a display area where the luminance brightness is 0 in the screen information such that at least the area of the display information on the corresponding item is displayed as blacked out on the display screen displayed on the operation panel 57. Alternatively, a path of a black image that is created in advance is set. The display screen generator 401 then outputs the screen information on which the display restriction process is performed to the second UI display unit 510.

When a notification indicating the start of a remote connection is issued from the remote performance determining unit 404, the display screen generator 401 notifies the operator determining unit 512 of the fact. This causes the operator determining unit 512 to reject to receive the operation information from the second operation receiver 514. The display screen generator 401 then outputs, to the remote screen transmitter 402, the screen information that is the source from which the display screen displayed on the second UI display unit 510 is generated. Furthermore, in this example, in order to notify the user B of the remote connection, the display screen generator 401 acquires screen information containing a message “Remote connection has been started” from the second storage unit of the main unit 40 and outputs the screen information to the second UI display unit 510. Accordingly, the display screen most recently displayed on the image processing apparatus 300 is displayed on the LCD 24 of the PC 200 and, on the operation panel 57 of the image processing apparatus 300, a message screen saying “Remote connection has been started” is displayed.

The second UI display unit 510 displays a display screen on the LCD of the operation panel 57 on the basis of the screen information that is output by the display screen generator 401 to the second UI display unit 510. Specifically, the second UI display unit 510 analyzes the screen information, converts the screen information into information on pixels configuring a display screen, and displays the display screen on the LCD of the operation panel 57.

The remote screen transmitter 402 transmits the screen information that is received from the display screen generator 401 to the remote screen receiver 206. Specifically, the remote screen transmitter 402 instructs the communication I/F 45 (see FIG. 4) to transmit the screen information whose destination is the address of the PC 200. According to the transmission instruction from the remote screen transmitter 402, the communication I/F 45 transmits the transmission data to the interface (I/F) 26 (see FIG. 3) in the LAN 5000 (see FIG. 2) via the LAN 6000 (se FIG. 2).

The display permissibility determination information saving unit 403 saves display permissibility determination information in the second storage unit of the main unit 40 or extracts information from the display permissibility determination information saved in the second storage unit. The display permissibility determination information is setting information representing settings on permissibility (“permitted” or “not permitted”) of display with respect to the display items on the screen according to each set of authority, such as the authority of “normal user” or the authority of “apparatus manager”.

FIG. 7 is a diagram of exemplary display permissibility determination information. The display permissibility determination information D1 illustrated in FIG. 7 includes “item list information” d1 representing display items, “authority information” d2 representing the type of authority, and “permissibility information” d3 representing whether it is permitted to display the display items. In this example, “normal user” d20 and “apparatus manager” d21 are provided as the “authority information” d2. Furthermore, “address book” d10, “manager setting” d11, “user information management” d12, and “copy use screen” d13 are provided as “item list information” d1. With respect to “permissibility information” d3, “not permitted” is set on display of “address book” d10, “manager setting” d11, and “user information management” d12, and “permitted” is set on display of other items.

The authentication determining unit 405 performs the authentication process by using the login information that is received from the operator determining unit 512 and determines whether it is permitted to login. The authentication determining unit 405 then notifies, for example, the display screen generator 401 of the authentication result. For example, when authentication is established, the authentication determining unit 405 notifies the display screen generator 401 of information representing that authentication is established and outputs the “user name” contained in the login information to the authentication state saving unit 406 as authority information. When authentication is not established, the authentication determining unit 405 notifies the display screen generator 401 of information representing that authentication is not established.

The authentication state saving unit 406 associates the authority information (the user name in this example), which is output when authentication is established by the authentication determining unit 405, with the operator information (identification information of the apparatus representing the operation source in the example) and saves them as the authentication information in the second storage unit. The authentication state saving unit 406 further extracts the authority information from the authentication information in the second storage unit.

FIG. 6 is a diagram of exemplary authentication information that is stored in the second storage unit.

The authentication information contains the authority information that is used by the user B for the latest login on the image processing apparatus 300 (the authority information on the image processing apparatus 300). The authentication information further contains the authority information that is used by the support person A during the remote operation for the latest login in the image processing apparatus 300 (the authority information on the PC 200).

In the authentication information D2 illustrated in FIG. 6, “MFP=user” d40 is represented as exemplary authentication information of the image processing apparatus 300 and “Remote=Administrator” d41 is represented as exemplary authentication information of the PC 200. The left side with respect to “=” represents operator information (identification information of the apparatus representing the operation source in this example) and the right side with respect to “=” represents the authority information corresponding to the operator information. Specifically, “MFP” represents identification information of the “image processing apparatus 300” and “Remote” represents the identification information of the “PC 200”. Furthermore, “user” represents a “normal user” and “Administrator” represents the “apparatus manager”. In short, “MFP=user” d40 represents that the user B most recently made a login by using the authority of “normal user” on the “image processing apparatus 300”. Furthermore, “Remote=Administrator” d41 represents that the support person A changed the authority to that of “apparatus manager” and then logged in the image processing apparatus 300 again during the remote operation from the “PC 200”.

In the example, it is assumed that, at the stage where the user B logs in the image processing apparatus 300 before a remote connection from the PC 200 is performed, the authentication state saving unit 406 sets the same initial value as that of the authority information of “MFP” as the initial value of the authority information of “Remote”. In this example, because the user B has the authority of “normal user”, “Remote=user” is set. After the remote connection, in accordance with the change of the authority from the PC 200, the authentication state saving unit 406 makes an update by, for example, rewriting the authority information of “Remote” with the authority information after the change.

The remote performance determining unit 404 manages the remote connection state with the external device. When there is a new request for a remote connection from the communication I/F 45, the remote performance determining unit 404 generates response data containing “connection possible” or “connection impossible” according to the state of the current remote connection and instructs the communication I/F 45 to sense back the response data to the remote start requester 204. When the remote performance determining unit 404 makes a response representing “connection possible” to the remote start requester 204, the remote performance determining unit 404 notifies the display screen generator 401 of the “start of a remote connection”.

The first operation receiver 202 corresponds to a first acceptance function that accepts first information. The second operation receiver 514 corresponds to a second reception function the accepts second information. The first UI display unit 208 and the second UI display unit 510 correspond to a first display function and a second display function that display display information, respectively. The display permissibility determination information saving unit 403 corresponds to a saving function that saves permissibility information representing whether to display the display information with respect to each set of authority information (display permissibility determination information) in the second storage unit. The operator determining unit 512, the authentication determining unit 405, and the authentication state saving unit 406 correspond to a login authentication function that, when first authority information for a login is accepted as the first information, performs authentication on the first authority information and performs a login process and, when second authority information for a login is accepted as the second information, performs authentication on the second authority information and performs a login process. The display screen generator 401 corresponds to a determination function that, when the first information is accepted, determines whether there is a difference between the first authority information and the second authority information on which authentication has been performed by the login authentication function on the login process. Furthermore, the display screen generator 401, the remote screen transmitter 402, and the remote screen receiver 206 correspond to a display control function that, when it is determined that there is no difference between the first authority information and the second authority information, outputs common display information as the display information to each of the first display function and the second display function and, when it is determined that there is the difference, performs a display restriction process so as not to display at least display information that is output to the second display function common with display information that is output to the first display function on the basis of the permissibility information.

Operations of the image processing system will be described here.

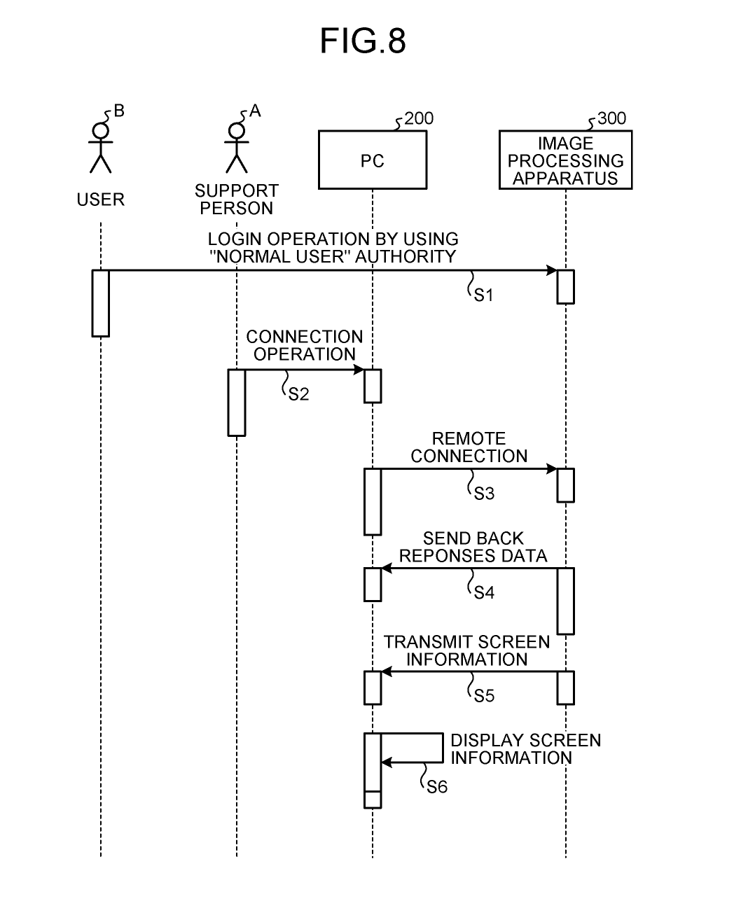

FIG. 8 is a sequence chart of exemplary operations of the image processing system performed when the support person A makes a remote connection to the image processing apparatus 300 from the PC 200 by using the same authority as that of the user B. The operations of the image processing system will be described with reference to FIGS. 3 to 5 as appropriate.

First of all, the user B logs in the image processing apparatus 300 by using the authority of “normal user” (S1). Specifically, the user B operates the operation panel 57 of the image processing apparatus 300 to input a user name (“user”) representing a “normal user” and a password. In the image processing apparatus 300, the second operation receiver 514 accepts the input information as login information and the operator determining unit 512 adds the operator information (“MFP” herein) to the login information. In the image processing apparatus 300, the authentication determining unit 405 performs authentication on the login information. When authentication is established, the authentication state saving unit 406 saves information (MFP=user) obtained by associating the user name with the operator information as the latest authentication information of “authority information on the image processing apparatus 300” in a second storage unit (such as the HDD 44). Thereafter, the user B operates the image processing apparatus 300 as appropriate according to the authority of “normal user” and, when a trouble occurs, makes an inquiry to the support person A with, for example, the mobile phone 600.

On the saving, the authentication state saving unit 406 saves information obtained by associating the initial information of authority information with the operator information of the PC 200 (“Remote” in this example) in the second storage unit (such as the HDD 44) as authentication information of the other set of “authority information on the PC 200”. In this example, “Remote=user” obtained by associating the authority information of “MFP” (in this case, “user”) with “Remote” is saved in the second storage unit as the initial information of the authority information.

In response to the inquiry from the user B, the support person A operates the PC 200 (S2) and remotely connects the PC 200 to the image processing apparatus 300 (S3). Specifically, at step S2, the support person A operates the input device 25 of the PC 200 to call the screen for establishing a remote connection. Furthermore, according to the screen for making a remote connection that is displayed by the first UI display unit 208 on the LCD 24, for example, the support person A specifies the image processing apparatus that is the remote connection partner or presses a connection request button. In accordance with this operation, in the PC 200, the first operation receiver 202 accepts a request for a remote connection to the image processing apparatus 300 at step S3. The remote start requester 204 then generates connection request data to the remote performance determining unit 404 and transmits the connection request data to the image processing apparatus 300. In this example, the remote start requester 204 transmits the connection request data to the address of the main unit 40 that is specified as the transmission destination in the image processing apparatus 300 that is specified on the screen.

On the other hand, upon receiving the connection request data, the image processing apparatus 300 sends back response data containing “connection possible” or “connection impossible” (S4). Specifically, in the image processing apparatus 300, the remote performance determining unit 404 sends back response data containing “connection possible” or “connection impossible” according to the state of the current remote connection.

At step S4, when the remote performance determining unit 404 sends back response data containing “connection possible” to the source of the request at step S4, the image processing apparatus 300 transmits screen information for performing a remote operation to the PC 200 (S5).

Specifically, in the image processing apparatus 300, the remote performance determining unit 404 notifies the display screen generator 401 of information representing the “start of a remote connection”. In response to this notification, in accordance with the output to the second UI display unit 510, the display screen generator 401 outputs the screen information that is the source from which the display screen displayed on the operation panel 57 is generated to the remote screen transmitter 402. In other words, he display screen generator 401 causes the LCD 24 of the PC 200 to display the display screen (operation screen) displayed on the operation panel 57 of the image processing apparatus 300 until that time. In is example, the display screen generator 401 acquires, from the second storage unit of the main unit 40, screen information containing a connection start message, such as “a remote connection has been started”, and outputs the screen information to the second UI display unit 510. Accordingly, on the operation panel 57 of the image processing apparatus 300, the display screen (operation screen) that is displayed until that time is updated to the screen containing the connection start message. Furthermore, in response to the notification from the remote performance determining unit 404, the display screen generator 401 notifies the operator determining unit 512 of information representing the “start of a remote connection”. This causes the operator determining unit 512 to reject to receive the operation information from the second operation receiver 514.

Upon receiving the screen information from the image processing apparatus 300, the PC 200 displays the screen information on the LCD 24 (S6). Accordingly, the display screen (operation screen) that is displayed on the image processing apparatus 300 is displayed on the LCD 24 of the PC 200.

Thereafter, the support person A remotely operates the image processing apparatus 300 from the PC 200. For example, the support person A performs an operation of switching the screen via the input device 25. Then, in the image processing apparatus 300, the display screen generator 401 acquires the switched screen information based on the information on the operation (operation information for normal users) from the second storage unit of the main unit 40. The display screen generator 401 then outputs the screen information to the remote screen transmitter 402 without performing the display restriction process. The operation information (“Remote”) representing a remote operation from the PC 200 is added to the operation information by the operator determining unit 512. For this reason, on the basis of the authentication information in the second storage unit of the main unit 40, the display screen generator 401 checks the difference between the authority information on the PC 200 and the authority information on the image processing apparatus 300. Both the sets of authority information are information representing a “normal user” (“user”). For this reason, without performing the display restriction process, the display screen generator 401 outputs a copy of the screen information to the second UI display unit 510. Accordingly, common display information without display restriction is displayed on each of the display screen of the LCD 24 of the PC 200 and the operation panel 57 of the image processing apparatus 300.

Operations of the image processing system that are performed when the support person A changes the authority and then logs in the image processing apparatus 300 again from the PC 200 will be described here.

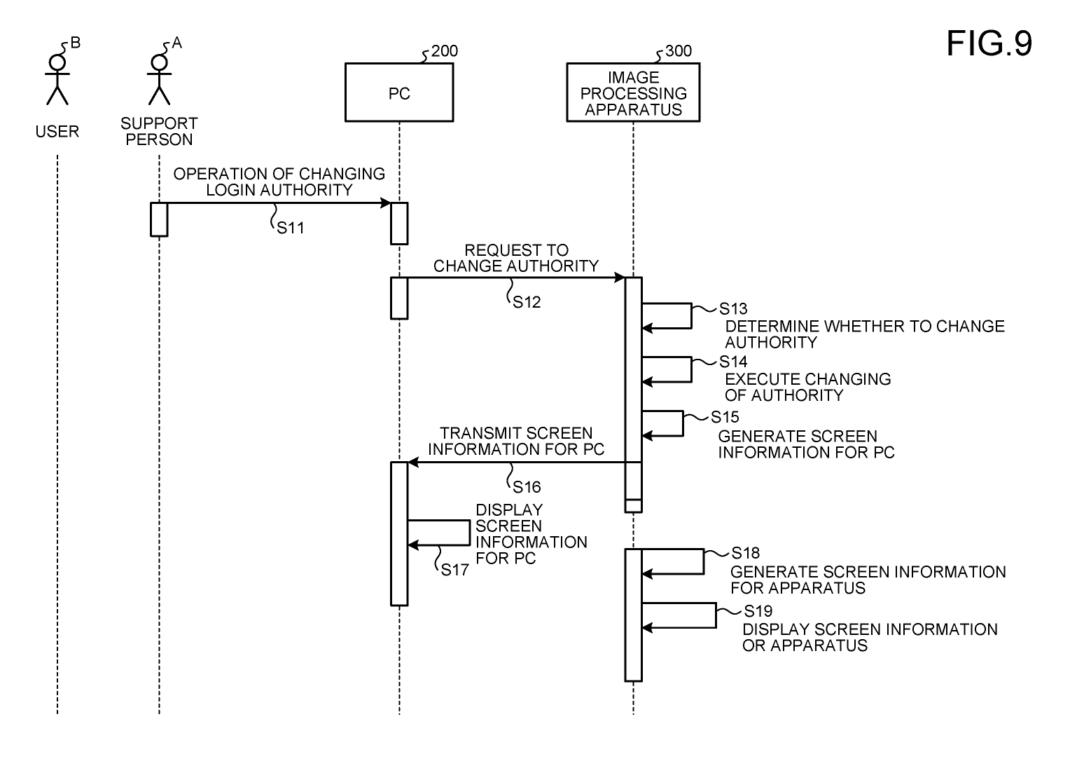

FIG. 9 is a sequence chart of exemplary operations of the image processing system performed when the support person A changes the authority and then logs in the image processing apparatus again from the PC 200. In this example, operations performed when, after making a remote connection to the image processing apparatus 300 from the PC 200 while keeping the authority of “normal user”, the support person A changes the authority of “normal user” to the authority of “apparatus manager” and then logs in the image processing apparatus 300 again. The operations of the image processing system will be described with reference to FIGS. 3 to 5 as appropriate.

First of all, the support person A performs an operation of logging in the image processing apparatus 300 again on the PC 200 by using another set of authority (authority of the apparatus manager) (S11). Specifically, the support person A remotely operates the image processing apparatus 300 from the input device 25 of the PC 200 to display the login change screen of the image processing apparatus 300 on the LCD 24. On the login change screen, the support person A inputs the user name (“Administrator”) after the change and the password from the input device 25.

Then, the PC 200 requests the image processing apparatus 300 to change the authority to that of “apparatus manager” (S12). Specifically, in the PC 200, the first operation receiver 202 accepts the input from the support person A as login information and transmits the login information to the operator determining unit 512 of the image processing apparatus 300.

The image processing apparatus 300 then determines whether to change the authority (S13). Specifically, in the image processing apparatus 300, the operator determining unit 512 adds operator information (“Remote”) to the received login information. Furthermore, in the image processing apparatus 300, the authentication determining unit 405 performs authentication on the login information to determine whether to change the authority. When authentication is established, the authentication determining unit 405 determines to change the authority.

Once authentication is established, the image processing apparatus 300 changes the authority (S14). In the image processing apparatus 300, in accordance with the change of the authority, the authentication state saving unit 406 updates the authentication information of the “authority information on the PC 200” that is saved in the second storage unit (such as the HDD 44). In this example, the initial information (“user”) contained as the authority information in the authentication information is updated with the user name (“Administrator”) after the change contained in the login information. Accordingly, the authentication information of the “authority information on the PC 200” is updated from “Remote=user” to “Remote=Administrator”.

The image processing apparatus 300 then generates screen information for the PC 200 (S15). Specifically, in the image processing apparatus 300, the authentication determining unit 405 notifies the display screen generator 401 of information representing the establishment of authentication. In response to the notification, the display screen generator 401 acquires screen information for the apparatus manager from the second storage unit of the main unit 40. On the basis of the screen information, the display screen generator 401 generates screen information for the PC 200. In this example, no restriction on display is given to the apparatus manager as represented by the display permissibility determination information D1 (see FIG. 7). For this reason, at step S15, without performing the display restriction process, the display screen generator 401 outputs the screen information for the PC to the remote screen transmitter 402.

The image processing apparatus 300 then transmits the screen information for the PC 200 to the PC 200 (S16). Specifically, in the image processing apparatus 300, once the screen information for the PC 200 is output from the display screen generator 401, the remote screen transmitter 402 transmits the screen information for the PC 200 to the remote screen receiver 206 of the PC 200.

In response to the transmission at step S16, the PC 200 receives the screen information for the PC 200 from the image processing apparatus 300 and displays the screen information on the LCD 24 (S17). Specifically, in the PC 200, the remote screen receiver 206 receives the screen information for the PC 200 that is transmitted from the image processing apparatus 300 and outputs the screen information to the first UI display unit 208. Accordingly, the first UI display unit 208 displays the screen for the apparatus manager of the image processing apparatus 300 on the LCD 24 without any display restriction.

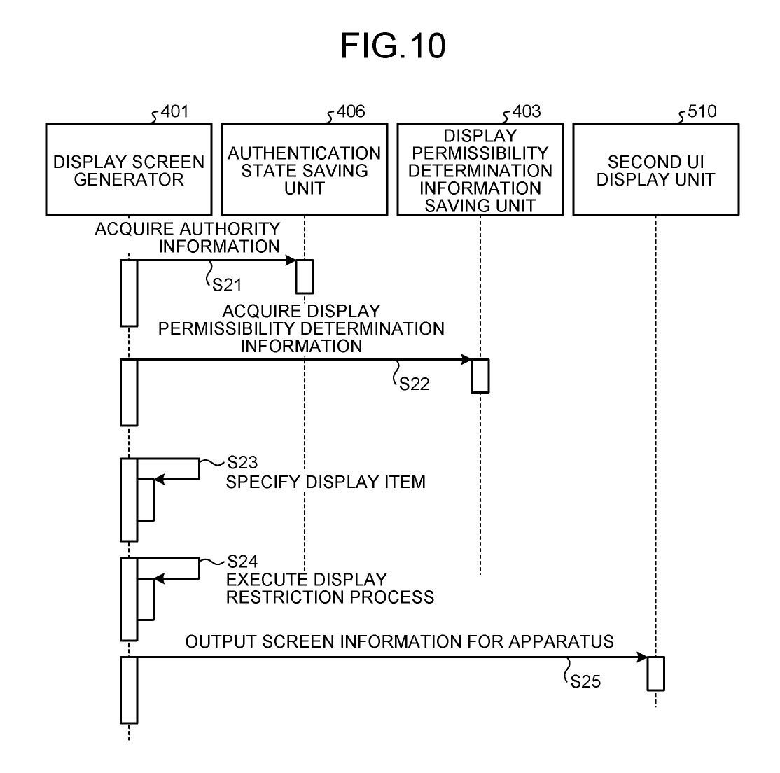

Following step S16, the image processing apparatus 300 generates screen information for the image processing apparatus 300 (S18). Specifically, in the image processing apparatus 300, the display screen generator 401 generates screen information for the image processing apparatus 300 in which display of part of or all the items is restricted on the basis of the screen information for the apparatus manager based on which the screen information for the PC 200 is generated. The flow of the process of generating screen information for the image processing apparatus 300 will be described below with reference to FIG. 10.

The image processing apparatus 300 displays the screen information for the image processing apparatus 300 (S19). Specifically, in the image processing apparatus 300, the display screen generator 401 outputs the screen information for the image processing apparatus 300 to the second UI display unit 510. Accordingly, the second UI display unit 510 displays, on the operation panel 57, the screen for the apparatus manager in which part of or all the items is restricted.

The flow of the process of generating screen information for the image processing apparatus 300 that is performed by the image processing apparatus 300 will be described here.

FIG. 10 is a sequence chart of an exemplary flow of the process of generating screen information for the image processing apparatus 300 that is performed by the image processing apparatus 300.

At step S13 illustrated in FIG. 9, operator information (“Remote”) representing that it is a remote operation from the PC 200 is added to the operation information (login information). Accordingly, first of all, the display screen generator 401 instructs the authentication state saving unit 406 to acquire the “authority information on the image processing apparatus 300” and the “authority information on the PC 200” (S21). In this example, the authentication information D2 illustrated in FIG. 7 is stored in the second storage unit. Accordingly, the display screen generator 401 acquires “user” corresponding to “MFP” and “Administrator” corresponding to “Remote” in the authentication information D2 from the authentication state saving unit 406.

There is a difference between the sets of authority information that are acquired by the authentication state saving unit 406 and therefore the display screen generator 401 instructs the display permissibility determination information saving unit 403 to acquire the display permissibility determination information from the second storage unit of the main unit 40 (S22). In this example, the display permissibility determination information D1 represented in FIG. 6 is stored in the second storage unit. Accordingly, the display screen generator 401 acquires the “item list information” d1 and its corresponding “permissibility information” d3 on “normal user” d20 from the display permissibility determination information saving unit 403.

The display screen generator 401 then acquires a copy of the screen information that is the source from which the screen information for the PC 200 generated at step S15 illustrated in FIG. 9 is generated and specifies display items corresponding to the “item list information” d1 in the screen information (copy) (S23).

The display screen generator 401 then checks the setting on the “permissibility information” d3 corresponding to the display items specified at step S23 and, for the “not permitted” setting, performs the display restriction process on the part corresponding to the “not permitted” display items in the screen information (copy) (S24). In the exemplary display restriction process, the display screen generator 401 specifies a display area where the luminance brightness is 0 in the screen information such that at least the display information area of the corresponding items is displayed as a blacked out area where the luminance bright ness is 0 on the display screen of the operation panel 57. For example, the whole area in which information is displayed on the display screen is specified as the display area where the luminance brightness is 0. Alternatively, an area in which information on the corresponding items is displayed on the display screen is specified as a display area where the luminance brightness is 0. Alternatively, in the display restriction process, display information, such as characters of the corresponding items, in the screen information may be set as not displayed.

The display screen generator 401 then outputs the screen information for the image processing apparatus 300 to the second UI display unit 510 (S25). In other words, the second UI display unit 510 displays, on the operation panel 57, the screen in which display of part of or all the items is restricted. Accordingly, the “screen for the apparatus manager” without display restriction is displayed on the LCD 24 of the PC 200 of the support person A and the “screen for the apparatus manager” in which the display is restricted is displayed on the operation panel 57 of the image processing apparatus 300 of the user B.

When the support person A remotely operates the image processing apparatus 300 from the PC 200, each screen is updated according to the operation. A screen without display restriction is displayed on the LCD 24 of the PC 200 of the support person A and a screen on which display is restricted according to the switched screen is displayed on the operation panel 57 of the image processing apparatus 300 of the user B. When the screen information does not contain any “not permitted” display item, the display screen generator 401 does not perform the display restriction process. Accordingly, in that case, a screen without restriction on display is displayed on both the LCD 24 of the PC 200 and the operation panel 57 of the image processing apparatus 300.

Exemplary displays of the display screen of the PC 200 and the display screen of the image processing apparatus 300 in the case where the display screen generator 401 performs the display restriction process will be described here. Exemplary displays made when the image processing apparatus 300 performs the display restriction process to display the display information area of the corresponding items on the display screen as blacked out will be described.

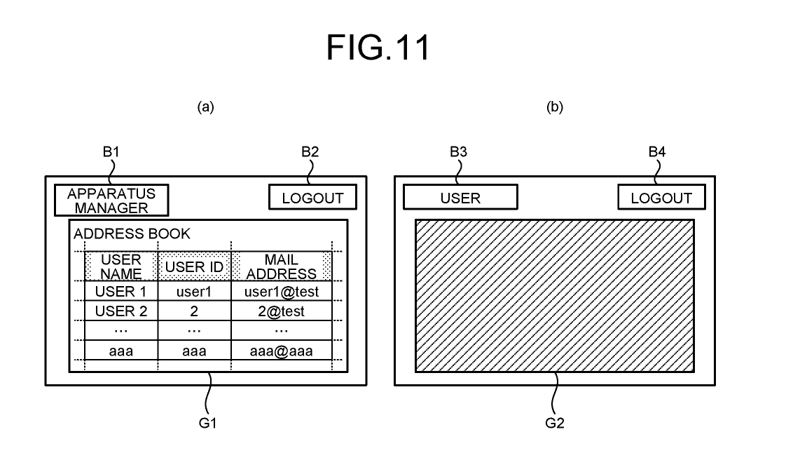

FIG. 11 is a diagram of exemplary displays of the display screen of the PC 200 and the display screen of the image processing apparatus 300, which are displayed when the display screen generator 401 performs the display restriction process. They are exemplary displays made when the support person A performs an operation of displaying the address book from the PC 200. As illustrated in the display permissibility determination information D1 (see FIG. 6), “permitted” is set with respect to “apparatus manager” d21 and “not permitted” is set with respect to “normal user” d20. For this reason, on the display screen of the image processing apparatus 300, part of or all the display information of the address book is restricted according to the specified area where the luminance brightness is 0. FIG. 11 shows the result of display obtained when all the area of the display information of the address book is specified as an area where the luminance brightness is 0.

FIG. 11(a) is the exemplary display of the display screen of the PC 200. As illustrated in FIG. 11(a), because the PC 200 does not have any restriction on display, an address book G1 and a screen switch buttons B1 and B2 are displayed.

FIG. 11(b) is the exemplary display of the display screen of the image processing apparatus 300. As illustrated in FIG. 11(b), on the image processing apparatus 300, the screen switch buttons B3 and B4 are displayed but all the area of the address book G1 is displayed in a blacked-out G2 because of the display restriction.

In the first embodiment, the display screen is displayed as blacked out by setting a display area where the luminance brightness is 0 in the screen information. Alternatively, instead of a setting of the luminance brightness of 0, for example, black may be set.

Furthermore, because it suffices if the corresponding display information is restricted, another luminance brightness or a color may be set to display the corresponding display information area in the display screen in the set color. Furthermore, a path of an image that is stored in the image information in advance (another image not containing the content of the display information) may be set to display the image on the display information area of the display screen. For example, a given image, such as an image to be displayed as blacked out on the display screen (blackout image) or an image having another color or another pattern, may be used as appropriate.

For easy understanding of the descriptions, the first embodiment has been described as one in which, after a remote connection from the PC 200 is started, reception of information on the operation performed by the user B from the second operation receiver 514 is rejected. Alternatively, a modification may be employed where, even after the remote connection from the PC 200 is started, reception of the information on the operation performed by the user B from the second operation receiver 514 can be continued. In this case, when the user B performs an operation on the image processing apparatus 300, the display screens of the PC 200 and the image processing apparatus 300 are updated. Also in this case, a screen with restriction on display is displayed on the display screen of the image processing apparatus 300 according to the setting of the display permissibility determination information.

Furthermore, in the first embodiment, the exemplary setting is represented in which “permitted” is set in “permissibility information” d3 on “apparatus manager” d21 with respect to all the items. Alternatively, as in “normal user” d20, “not permitted” may be set in “permissibility information” d3 with respect to “apparatus manager” d21. For example, settings may be made as appropriate with respect to each item such that, for example, an item that is “permitted” to display to “normal user” d20 is “not permitted” to display to the “apparatus manger”. In this case, in the same manner mainly as that of the process from step S22 to S24, screen information for the PC 200 and screen information for the image processing apparatus 300 on which the display restriction process is performed with respect to display items corresponding to “not permitted” are generated.

Furthermore, with respect to the first embodiment, the mode where the hardware of the operation unit 50 and the hardware of the main unit 40 are configured of different computers, respectively, in the image processing apparatus 300 and data communications are performed between them according to, for example, the USB standard. Alternatively, for example, the main unit 40 may be provided with the operation panel 57 and the external connection I/F 58 to enable the CPU 41 of the main unit 40 to implement the functions of the main unit 40 and the operation unit 50.

As described above, the image processing system of the first embodiment includes the input device 25 and the first operation receiver 202 that serve as a first input unit for inputting first information, such as operation information. The image processing system further includes the operation panel 57 and the second operation receiver 514 that serve as a second input unit also for inputting second information, such as operation information. The image processing system further includes the LCD 24 and the first UI display unit 208 that serve as a first display unit that displays display information. The image processing system further includes the operation panel 57 and the second UI display unit 510 that serve as a second display unit that displays display information. The image processing system further includes the second storage unit and the display permissibility determination information saving unit 403 that serve as a storage unit that stores permissibility information (display permissibility determination information) with respect to each set of authority information representing whether to display the display information. The image processing system further includes the communication I/F 45, the operator determining unit 512, the authentication determining unit 405, and the authentication state saving unit 406 that serve as a login authentication processing unit that, when first authority information (authority information on, for example, an apparatus manager) for a login is input from the first input unit as the first information, performs authentication on the first authority information and performs a login process and, when second authority information (authority information on, for example, a normal user) for a login is input from the second input unit as the second information, performs authentication on the second authority information and performs a login process. The image processing system further includes the display screen generator 401 serving as a determining unit that, when the first information is input from the first input unit, determines whether there is a difference between the first authority information and the second authority information on which authentication has been performed by the login authentication processing unit on the login process. The image processing system further includes the display screen generator 401, the communication I/F 45, the remote screen transmitter 402, the I/F 26, and the remote screen receiver 206 that serve as a display control unit that, when the determining unit determines that there is no difference between the first authority information and the second authority information, causes the first display unit and the second display unit to display common display information and, when the determining unit determines that there is the difference, imposes a restriction on display of at least display information common with display information that the first display unit is caused to display, which is the display performed by the second display unit, on the basis of the permissibility information in the storage unit.

Furthermore, the information processing apparatus illustrated as the image processing apparatus in the first embodiment includes the operation panel 57 and the second operation receiver 514 that serve as a second input unit for inputting second information, such as operation information. The information processing apparatus further includes the communication I/F 45 and the remote screen transmitter 402 that serve as a transmitter that transmits display information to a remote apparatus that remotely operates the image processing apparatus 300. The information processing apparatus further includes the operation panel 57 and the second UI display unit 510 that serve as a second display unit that displays the display information. The information processing apparatus further includes the second storage unit and the display permissibility determination information saving unit 403 that serve as a storage unit that stores permissibility information with respect to each set of authority information representing whether to display the display information. The information processing apparatus further includes the communication I/F 45, the operator determining unit 512, the authentication determining unit 405, and the authentication state saving unit 406 that serve as a login authentication processing unit that, when first authority information for a login is input from the remote apparatus as first information, performs authentication on the first authority information and performs a login process and, when second authority information for a login is input from the second input unit as the second information, performs authentication on the second authority information and performs a login process. The information processing apparatus further includes the display screen generator 401 serving as a determining unit that, when the first information is input from the remote apparatus, determines whether there is a difference between the first authority information and the second authority information on which authentication has been performed by the login authentication processing unit on the login process. The information processing apparatus further includes the display screen generator 401 and the remote screen transmitter 402 that serve as a first display control unit that, when the determining unit determines that there is no difference between the first authority information and the second authority information, causes the transmitter to transmit the display information and causes the second display unit to display the display information and, when the determining unit determines that there is the difference, imposes a restriction on display of at least display information common with the display information that the transmitter is caused to display, which is the display performed by the second display unit, on the basis of the permissibility information in the storage unit.

As described above, according to the first embodiment, because information representing whether it is permitted to give a display to a normal user is set in the permissibility information, it is possible to conceal information to be displayed on the image processing apparatus 300 by performing a display restriction process. For example, in the case where the support person A performs a remote operation to remotely operate the operation screen of the image processing apparatus 300, the support person A is able to impose a restriction on display of, for example, setting information on the operation screen of the image processing apparatus 300 in order to fix the inconvenience. This inhibits the user B of the image processing apparatus without authority from accessing information on which the user B does not have authority.

### Second Embodiment

The first embodiment exemplifies the mode where the display items to be displayed by the image processing apparatus 300 own are determined by the image processing apparatus 300 own. A second embodiment of the present invention represents a mode where the PC 200 makes the above-described determination. Different aspects from those of the first embodiment will be mainly described below and components common to the first and second embodiments will be, for example, denoted with the same reference numbers to omit illustrations and descriptions as appropriate.

The image processing system according to the second embodiment is different from that of the first embodiment mainly with respect to the functions of the PC 200 and the image processing apparatus 300 of the first embodiment. The difference between the functions of a PC and an image processing apparatus of the image processing system according to the second embodiment and the operations of the image processing system according to the first embodiment will be described below.

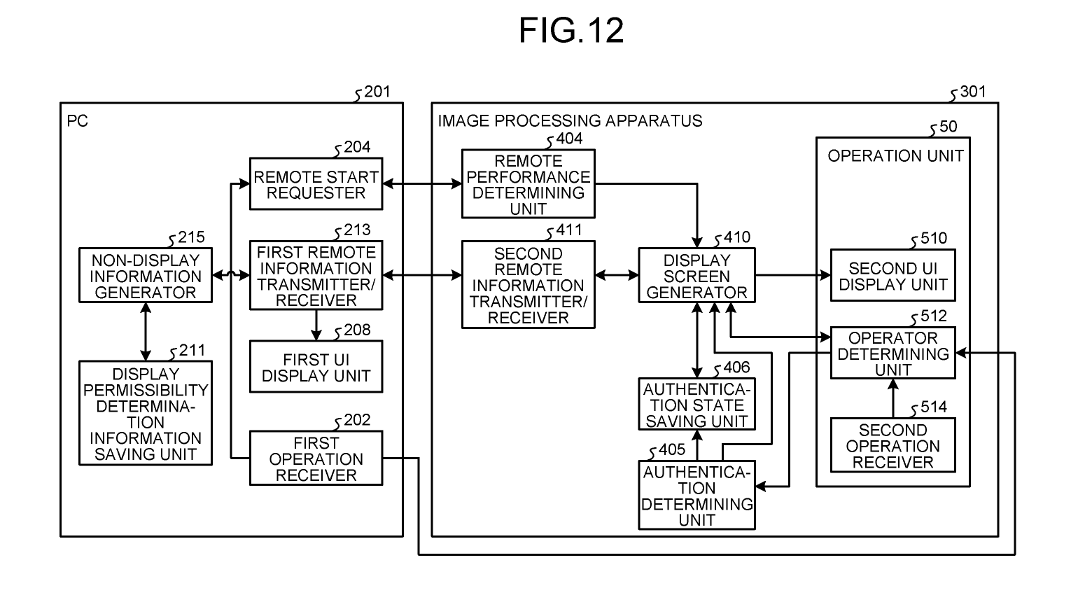

FIG. 12 is a diagram of an exemplary functional block of a PC 201 and an image processing apparatus 301 of the image processing system according to the second embodiment. The PC 201 illustrated in FIG. 12 is obtained by providing the display permissibility determination information saving unit 403 of the image processing apparatus 300 (see FIG. 5) as a display permissibility determination information saving unit 211. The PC 201 further includes a first remote information transmitter/receiver 213 with which the remote screen receiver 206 of the PC 200 (see FIG. 5) is replaced. Furthermore, the PC 201 further includes a non-display information creator 215. On the other hand, the image processing apparatus 301 is obtained by providing the display screen generator 401 of the image processing apparatus 300 (see FIG. 5) as a display screen generator 410. The image processing apparatus 301 further includes a second remote information transmitter/receiver 411 with which the remote screen transmitter 402 of the image processing apparatus 300 (see FIG. 5) is replaced. The image processing apparatus 301 does not include the display permissibility determination information saving unit 403 (see FIG. 5) because the PC 201 includes it the display permissibility determination information saving unit 403 as a display permissibility determination information saving unit 211.

Various functional units corresponding to inquiry to the display permissibility determination information saving unit 211 will be described as functional units different from those of the first embodiment. The display screen generator 410, the second remote information transmitter/receiver 411, the first remote information transmitter/receiver 213, the non-display information creator 215, and the display permissibility determination information saving unit 211 will be described mainly.

The display screen generator 410 has basic functions, such as a function of generating screen information for the PC 201 and screen information for the image processing apparatus 301 (for the image processing apparatus own), that are common with those of the display screen generator 401 represented in the first embodiment (see FIG. 5). Note that the display screen generator 410 is different from the display screen generator 401 in that, when generating screen information for the image processing apparatus, the display screen generator 410 requests the PC 201 to determine whether display is permitted with respect to an item incorporated in screen information.

Specifically, assume that information (“Remote”) representing that it is a remote operation from the PC 201 is added to operation information that is output by the operator determining unit 512. Assume that, in the authentication information that is saved in the second storage unit by the authentication state saving unit 406 (for example, the authentication information D2 in FIG. 7), the authority information used for a login on the image processing apparatus 301 is “user” and the authority information used for a login from on the PC 201 is “Administrator”, i.e., there is a difference between the sets of authority information. In that case, as the display screen generator 401 of the first embodiment does, the display screen generator 410 outputs given screen information that is stored in the second storage unit as screen information for the PC 201 to the second remote information transmitter/receiver 411. In the second embodiment, the display screen generator 410 further outputs request information for requesting determination on whether display is permitted to the second remote information transmitter/receiver 411. The display screen generator 410 incorporates, in the request information, information (“user”) representing “normal user” as authority information used for a login on the image processing apparatus 301.

The display screen generator 410 receives, as a response to the request from the PC 201, information for concealing an item that is not admitted to be displayed to a user with authority of “normal user” from the second remote information transmitter/receiver 411. Then, according to the received information, the display screen generator 410 performs a display restriction process of concealing part of or all the display information in a copy of the screen information, which is the source from which the screen information that is output to the second remote information transmitter/receiver 411 is generated, and generates screen information for the image processing apparatus. Specifically, assume that the display screen generator 410 receives coordinate information representing the display area of the specified item as information for concealing the item. In that case, information for displaying the display information corresponding to the area represented by the coordinate information as blacked out on the display screen is set in the screen information. For example, information for specifying the pixels of the display screen in the area specified by the coordinate information is set in the screen information. The display screen generator 410 then outputs the screen information containing the setting for displaying part or all the display screen as blacked out to the second UI display unit 510 as the screen information for the image processing apparatus.

The second remote information transmitter/receiver 411 has an aspect that it transmits screen information for the PC 201, which is an aspect common with that of the remote screen transmitter 402 (see FIG. 5) represented in the first embodiment. Note that the second remote information transmitter/receiver 411 is different from the remote screen transmitter 402 in that it performs data communications with the PC 201 for a request for determining whether display is permitted and its corresponding response. The second remote information transmitter receiver 411 generates transmission data for transmitting the request information on determination on whether display is permitted, which is the request information received from the display screen generator 410, to the first remote information transmitter/receiver 213 of the PC 201. The second remote information transmitter/receiver 411 transmits the transmission data from the communication I/F 45 (see FIG. 4) via the LAN 6000 (see FIG. 2) to the interface (I/F) 26 (see FIG. 3) in the LAN 5000 (see FIG. 2). Furthermore, the second remote information transmitter/receiver 411 receives information representing the determination result and the information for concealing an item not admitted to be displayed as the response from the first remote information transmitter/receiver 213 via the communication I/F 45.

The first remote information transmitter/receiver 213 has an aspect that it receives generation source screen information that is same as the screen displayed on the image processing apparatus 301 during a remote connection and outputs the screen information to the first UI display unit 208, which is an aspect common with that of the remote screen receiver 206 (see FIG. 5) represented in the first embodiment. Note that the first remote information transmitter/receiver 213 is different from the remote screen receiver 206 in that it performs data communications with the image processing apparatus 301 for a request for determination on whether display is permitted and for its corresponding response. Upon receiving the request information on determination on whether display is permitted from the image processing apparatus 301, the first remote information transmitter/receiver 213 requests the non-display information creator 215 to meet the request. Upon receiving, as its corresponding response, information representing the determination result from the non-display information creator 215, the first remote information transmitter/receiver 213 then generates transmission data to be transmitted to the second remote information transmitter/receiver 411 of the image processing apparatus 301. The first remote information transmitter/receiver 213 then transmits as a response to the request, the transmission data from the interface (I/F) 26 (see FIG. 3) via the LAN 5000 (see FIG. 2) to the communication I/F 45 (see FIG. 4) in the LAN 6000 (see FIG. 2).

The non-display information creator 215 acquires display permissibility determination information (for example, the display permissibility determination information D1 illustrated in FIG. 6) from the display permissibility determination information saving unit 211. Furthermore, on the basis of the authority information representing “normal user” contained in the request information received by the first remote information transmitter/receiver 213, the non-display information creator 215 then extracts a list of setting items and setting values representing “permitted” or “not permitted” with respect to “normal user”. Furthermore, the non-display information creator 215 specifies an area not permitted to view in a copy of the screen information received by the first remote information transmitter/receiver 213. The non-display information creator 215 then generates information enabling the corresponding area to be concealed on the display on the image processing apparatus 301 and outputs the information together with information representing the determination result (for example, information of an instruction for restricting the display) to the first remote information transmitter/receiver 213. The non-display information creator 215 generates and outputs, as the information enabling the corresponding area to be concealed, for example, coordinate information that specifies the display area of the information on the item not permitted to view.

The display permissibility determination information saving unit 211 saves the display permissibility determination information in the first storage unit of the PC 201. The function of the display permissibility determination information saving unit 211 is same as that described with respect to the display permissibility determination information saving unit 403 of the first embodiment (see FIG. 5) and therefore further descriptions will be omitted here.

The first operation receiver 202 corresponds to a first acceptance function that accepts first information. The second operation receiver 514 corresponds to a second reception function that accepts second information. The first UI display unit 208 and the second UI display unit 510 correspond to a first display function and a second display function that display display information, respectively. The display permissibility determination information saving unit 211 corresponds to a saving function that saves permissibility information (display permissibility determination information) representing whether to display the display information with respect to each set of authority information in the first storage unit. The operator determining unit 512, the authentication determining unit 405, and the authentication state saving unit 406 correspond to a login authentication function that, when first authority information for a login is accepted as the first information, performs authentication on the first authority information and performs a login process and, when second authority information for a login is accepted as the second information, performs authentication on the second authority information and performs a login process. The display screen generator 410 corresponds to a determination function that, when the first information is accepted, determines whether there is a difference between the first authority information and the second authority information on which authentication is performed by the login authentication function on the login process. The second remote information transmitter/receiver 411 corresponds to a transmission function that transmits a creation-requesting request with respect to the display information and display restriction information that are displayed by the first display function. The first remote information transmitter/receiver 213 corresponds to a reception function that receives the creation-requesting request. The non-display information creator 215 corresponds to a creation function that, When the creation-requesting request is received, creates display restriction information that restricts display of the display information on the basis of the permissibility information in the first storage unit. The first remote information transmitter/receiver 213 corresponds to a restriction information transmission function that transmits the created display restriction information to the request source. The second remote information transmitter/receiver 411 corresponds to a restriction information reception function that receives the display restriction information. The display screen generator 410 correspond to a display control function that, when it is determined that there is no difference between the first authority information and the second authority information, outputs common display information as the display information to each of the transmission function and the second display function and, when it is determined that there is the difference, outputs the display information and the creation-requesting request to the transmission function and outputs display information based on the display restriction information received by the restriction information reception function to the second display function.

Operations of the image processing system of the second embodiment will be described here.

Operations of the image processing system of the second embodiment will be described by exemplifying the case represented in the first embodiment. In other words, first of all, the user B logs in the image processing apparatus 301 by using the authority of “normal user” and then, in accordance with an inquiry from the user B, the support person A logs in the image processing apparatus 301 from the PC 201 while keeping the authority of “normal user” (first step). The support person A then changes the authority to that of “apparatus manager” and logs in the image processing apparatus 301 again from the PC 201 (second step). The sequence chart representing the first step is same as the sequence chart (see FIG. 8) that is referred to for the first embodiment and, because descriptions thereof are redundant, illustrations and descriptions thereof will be omitted.

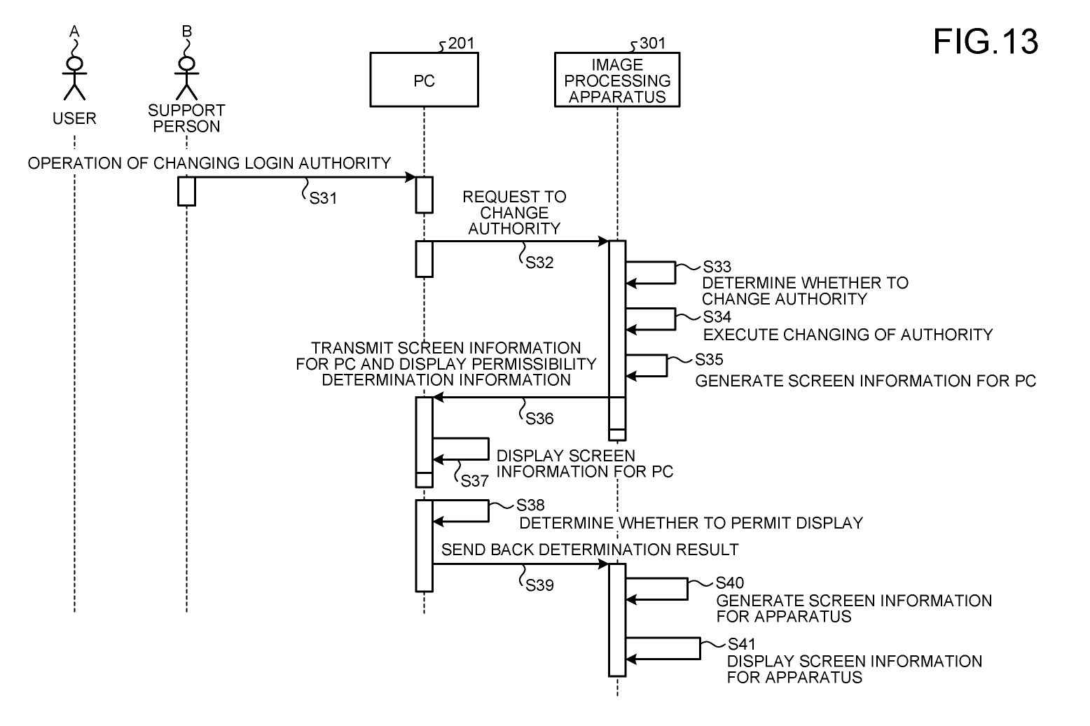

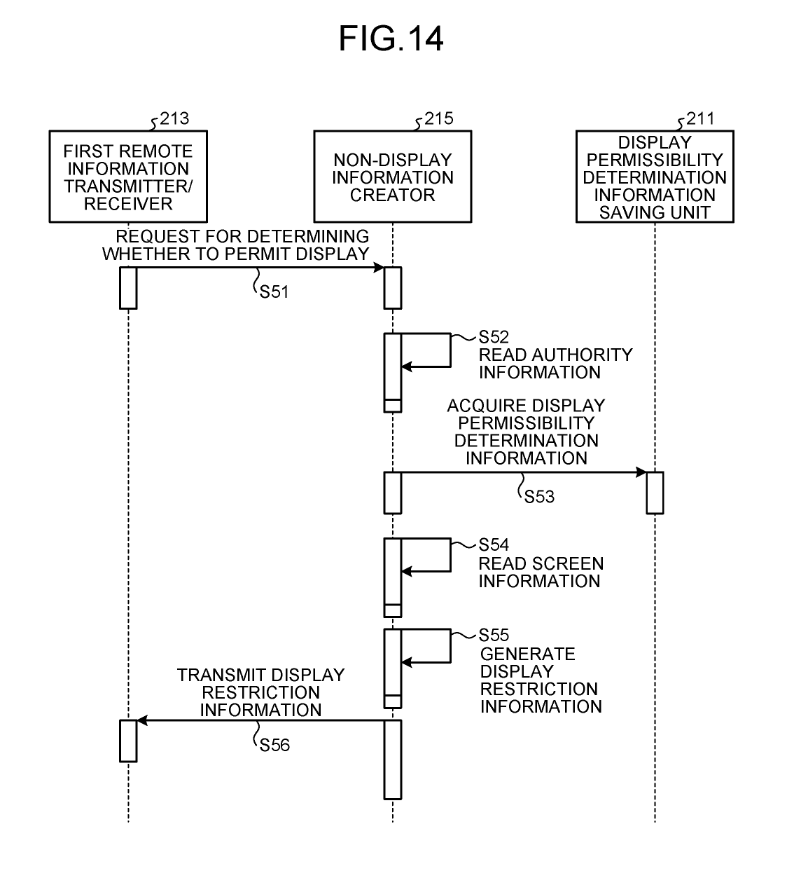

The operations of the image processing system at the second step will be described with reference to FIGS. 13 and 14. For the descriptions, FIGS. 3 to 5 will be referred to as appropriate.

FIG. 13 is a sequence chart of exemplary operations of the image processing system performed when the support person A changes the authority to that of “apparatus manager” and logs in the image processing apparatus 301 again from the PC 201. Steps S31, S32, S33, S34 and S35 in FIG. 13 correspond to step S11, S12, S13, S14 and S15 in the sequence chart (see FIG. 9) described with respect to the first embodiment, respectively. The operations of the steps are same as those of the first embodiment and descriptions thereof should be referred to, and operations from step S36 following step S35 will be described here.

At step S36, the image processing apparatus 301 transmits screen information for the PC 201 to the PC 201. Furthermore, the image processing apparatus 301 transmits, to the PC 201, request information (request information on determination on whether display is permitted) inducing the PC 201 to determine whether to conceal display information with respect to screen information to be generated for the image processing apparatus. Specifically, in the image processing apparatus 301, the display screen generator 410 instructs the second remote information transmitter/receiver 411 to transmit the screen information for the PC 201 and the request information for determining whether display is permitted. The request information for determining whether display is permitted incorporates, for example, the authority information (“normal user”) on the login in the image processing apparatus 301 that is acquired by the display screen generator 410 from the authentication state saving unit 406. In response to the instruction from the display screen generator 410, the second remote information transmitter/receiver 411 transmits the screen information for the PC 201 and the request information for determining whether display is permitted to the first remote information transmitter/receiver 213 of the PC 201.

Upon receiving the screen information, the PC 201 displays the screen on the LCD 24 (S37). Specifically, in the PC 201, the first remote information transmitter/receiver 213 receives the screen information that is transmitted from the image processing apparatus 301 and outputs the screen information to the first UI display unit 208. Accordingly, the first UI display unit 208 displays the screen of the image processing apparatus 301 on the LCD 24. The first remote information transmitter/receiver 213 saves a copy of the screen information in the first storage unit of the PC 201 for a process of determining whether display is permitted (see FIG. 14), which will be described below.

The process of determining whether display is permitted that is performed by the PC 201 (corresponding to step S38 and step S39) will be described briefly.

Upon receiving the request information for determining whether display is permitted, the PC 201 performs the process of determining whether display is permitted, which is the content of the request (S38). Specifically, upon receiving the request information for determining whether display is permitted from the image processing apparatus 301, the PC 201 generates, in accordance with an item that is not admitted to be displayed to “normal user” that is set in the display permissibility determination information in the first storage unit, information for concealing the item (coordinate information).

The PC 201 then sends back the result of the above-described determination process to the image processing apparatus 301 (S39). Specifically, in the PC 201, the first remote information transmitter/receiver 213 receives, as the determination result, information for concealing the item not admitted to be displayed with respect to the authority of “normal user” (such as coordinate information) from the non-display information creator 215. The first remote information transmitter/receiver 213 then sends back the information as response information to the second remote information transmitter/receiver 411 of the image processing apparatus 301.

In response to the sending back from the PC 201 at step S39, the image processing apparatus 301 receives the information representing the determination result as response information corresponding to the request information and, on the basis of the information, generates screen information for the image processing apparatus (S40).

Specifically, in the image processing apparatus 301, the second remote information transmitter/receiver 411 receives information for concealing the item not admitted to be displayed with respect to the authority of “normal user” (such as coordinate information) as the information representing the determination result. The display screen generator 410 then performs, in accordance with the received information, a process of, for example, concealing part of all the display information in the screen information that is the source from which the screen information output to the second remote information transmitter/receiver 411 is generated and generates screen information for the image processing apparatus. For example, assume that the display screen generator 410 receives, as the information for concealing the item not admitted to view with respect to the authority of “normal user”, coordinate information representing an area in which the information on the item is displayed. In this case, the display screen generator 410 sets, as the screen information, specifying information for displaying the area represented by the coordinate information as blacked out, such as information that specifies the luminance brightness of the pixels in the area at 0. The display screen generator 410 then outputs the screen information containing the specifying information as the screen information for the image processing apparatus to the second UI display unit 510.

The image processing apparatus 301 then displays the screen information for the image processing apparatus (S41). Specifically, in the image processing apparatus 301, the display screen generator 410 outputs the screen information for the image processing apparatus to the second UI display unit 510. Accordingly, the second UI display unit 510 analyzes the screen information and, for example, converts the screen information to information of pixels configuring the display screen and displays the information on the operation panel 57.

The flow of the process on the screen information containing the item not admitted to be displayed with respect to the authority of “normal user” has been described. With respect to the screen information not containing the item, the image processing apparatus 301 receives an “instruction without restriction on display” as the determination result from the PC 201. Accordingly, the image processing apparatus 301 outputs the copy of the screen information that is output to the PC 201 to the screen of the image processing apparatus without putting a display restriction on the copy.

The flow of the process of determining whether display is permitted that is performed by the PC 201 will be described here.

FIG. 14 is a sequence chart of an exemplary detailed flow of the process of determining whether display is permitted that is performed by the PC 201.

First of all, upon receiving request information for determining whether display is permitted that is transmitted from the image processing apparatus 301, the first remote information transmitter/receiver 213 saves authority information (“normal user”) contained in the request information and screen information (copy) in the first storage unit of the PC 201. The first remote information transmitter/receiver 213 then requests the non-display information creator 215 to execute the process of determining whether display is permitted, which is the content of the request (S51)

The non-display information creator 215 then reads the authority information (normal user) saved in the first storage unit of the PC 201 (S52).

The non-display information creator 215 then instructs the display permissibility determination information saving unit 211 to acquire display permissibility determination information in the first storage unit of the PC 201 (S53). For example, assume that the display permissibility determination information D1 is stored in the first storage unit of the PC 201. In this case, the non-display information creator 215 acquires “item list information” d1 and its corresponding “permissibility information” d3 on “normal user” d20 from the display permissibility determination information saving unit 211.

The non-display information creator 215 then reads the screen information (copy) that is saved in the first storage unit of the PC 201 (S54).

On the basis of the screen information that is read at step S54, the non-display information creator 215 generates information (coordinate information) for concealing information of a corresponding area of the item with respect to which “not permitted” is set in the “permissibility information” d3 (S55).

The non-display information creator 215 then outputs the information as the result of the determination process to the first remote information transmitter/receiver 213 (S56). Accordingly, the first remote information transmitter/receiver 213 sends back the information as response information to the second remote information transmitter/receiver 411 of the image processing apparatus 301.

The process performed when an item not admitted to be displayed is incorporated in the screen information has been described here. On the other hand, when the item is not incorporated in the screen information, the following process is performed. At step S56, the non-display information creator 215 outputs “information representing that there is no display restriction” as the result of the determination process to the first remote information transmitter/receiver 213. Accordingly, the first remote information transmitter/receiver 213 sends back the information as response information to the second remote information transmitter/receiver 411 of the image processing apparatus 301.

In the second embodiment, the image processing apparatus 301 transmits, as a creation-requesting request, request information requesting determination on whether display is permitted to the PC 201. The PC 201 then creates coordinate information representing the display area of the information of the item not permitted to be displayed and sends back the coordinate information to the image processing apparatus 301. The PC 201 may create, instead of the coordinate information, another type of information as display restriction information and send back the information to the image processing apparatus 301.

For example, the PC 201 may create and send back identification information representing an item not permitted to be displayed as display restriction information. This enables the image processing apparatus 301 to make a setting for causing the information of the item not to be displayed or to be in a state equivalent to the state of not being displayed. Alternatively, the image processing apparatus 301 may transmit request information requesting generation of screen information as the creation-requesting request to the PC 201 and acquire screen information on which the display restriction process has been performed from the PC 201. In this case, on the basis of the screen information for the PC 201 that is transmitted from the image processing apparatus 301, the PC 201 creates screen information to be displayed on the image processing apparatus 301 as display restriction information and sends back the screen information to the image processing apparatus 301. When the screen information for the PC 201 contains an item not permitted to be displayed, for example, the PC 201 generates and sends back screen information in which the luminance brightness of the area is set at 0. Accordingly, the process of generating screen information that is performed by the image processing apparatus 301 can be omitted. Alternatively, a partial image (for example, a given image, such as a blackout image) in a size that conceals an information display area on the item not permitted to be displayed on the display screen of the operation panel 57 may be created as display restriction information and sent back to the image processing apparatus 301. This allows the image processing apparatus 301 to complete the display restriction process by setting the partial image in the screen information and therefore it is unnecessary to store or generate a partial image in advance.

As described above, the image processing system of the second embodiment includes the input device 25 and the first operation receiver 202 that serve as a first input unit for inputting first information, such as operation information. The image processing system further includes the operation panel 57 and the second operation receiver 514 that serve as a second input unit also for inputting second information, such as operation information. The image processing system further includes the LCD 24 and the first UI display unit 208 that serve as a first display unit that displays display information. The image processing system further includes the operation panel 57 and the second UI display unit 510 that serve as a second display unit that displays display information. The image processing system further includes the first storage unit and the display permissibility determination information saving unit 211 that serve as a storage unit that stores permissibility information (display permissibility determination information) with respect to each set of authority information representing whether to display the display information. The image processing system further includes the communication I/F 45, the operator determining unit 512, the authentication determining unit 405, and the authentication state saving unit 406 that serve as a login authentication processing unit that, when first authority information (authority information on, for example, an apparatus manager) for a login is input from the first input unit as the first information, performs authentication on the first authority information and performs a login process and, when second authority information (authority information on, for example, a normal user) for a login is input from the second input unit as the second information, performs authentication on the second authority information and performs a login process. The image processing system further includes the display screen generator 410 serving as a determining unit that, when the first information is input from the first input unit, determines whether there is a difference between the first authority information and the second authority information on which authentication has been performed by the login authentication processing unit on the login process. The image processing system further includes the display screen generator 410, the communication I/F 45, the second remote information transmitter/receiver 411, the I/F 26, the first remote information transmitter/receiver 213, and the non-display information creator 215 that serve as a display control unit that, when the determining unit determines that there is no difference between the first authority information and the second authority information, causes the first display unit and the second display unit to display common display information and, when the determining unit determines that there is the difference, imposes a restriction on display of at least display information common with display information that the first display unit is caused to display, which is the display performed by the second display unit, on the basis of the permissibility information in the storage unit.

Furthermore, the information processing apparatus illustrated as a remote operation terminal (PC) in the second embodiment includes the input device 25 and the first operation receiver 20 that serve as a first input unit for inputting first information. The information processing apparatus further includes the LCD 24 and the first UI display unit 208 that serve as a first display unit that displays display information. The information processing apparatus further includes the I/F 26 and the first operation receiver 202 that serve as an input information transmitter that transmits the first information that is input by the first input unit to an information processing apparatus (image processing apparatus) to be remotely operated. The information processing apparatus further includes the I/F 26 and the first remote information transmitter/receiver 213 that serve as a reception unit that receives a creation-requesting request with respect to the display information and display restriction information that the first display unit is caused to display. The information processing apparatus further includes the first storage unit and the display permissibility determination information saving unit 211 that serve as a storage unit that stores, with respect to each set of authority information, permissibility information representing whether to display the display information on the information processing apparatus to be remotely operated. The information processing apparatus further includes the non-display information creator 215 that serves as a creator that, when the reception unit receives the creation-requesting request, creates display restriction information that restricts display of the display information on the information processing apparatus to be remotely operated on the basis of the permissibility information in the storage unit. The information processing apparatus further includes the I/F 26 and the first remote information transmitter/receiver 213 that serve as a restriction information transmitter that transmits the display restriction information that is created by the creator to the information processing apparatus to be remotely operated.

As described above, in the second embodiment, the information representing whether display is permitted to normal users is set in the permissibility information in the PC 201, which makes it possible to conceal information displayed on the image processing apparatus 301 by performing the display restriction process. Accordingly, it is possible to prevent the user B of the image processing apparatus 301 from viewing information that the user B does not have authority to view.

Furthermore, because it suffices if the data of the display permissibility information of the PC 201 is only updated when there is a change in items viewable by users having authority of “apparatus manager” or “normal user”, it is unnecessary to update data of the image processing apparatus 301. Accordingly, it is unnecessary to update data of each of the image processing apparatuses 301 distributed over the country and it suffices if the data of the PCs 201 that are collectively set to some extent is only updated, which improves usability on a change of items to be viewed.

### Third Embodiment

In a third embodiment of the present invention, a mode different from the process for blacked out display will be represented as the display restriction process represented in the first embodiment. An exemplary process of causing displaying information on an item not permitted to be displayed not to be displayed or to be in a state equivalent to the state of not being displayed.

As represented in the first embodiment, the display screen generator 410 specifies an item not permitted to be displayed in screen information that is acquired from the second storage unit of the main unit 40. In the third embodiment, the display screen generator 401 sets, in the screen information, setting information for causing displaying information on the specified item not to be displayed or to be in a state equivalent to the state of not being displayed. For example, assume that the display information is character information. In this case, the display screen generator 401 sets, in the screen information, specifying information that specifies character information not to be displayed on the display screen or a character color same as that background color for causing the character information to be in a state equivalent to the state of not being displayed visually on the display screen. The second UI display unit 510 interprets the setting and displays, on the operation panel 57, a display screen on which the display information corresponding to the item not permitted to be displayed is caused not to be displayed or to be in a state equivalent to the state of not being displayed.

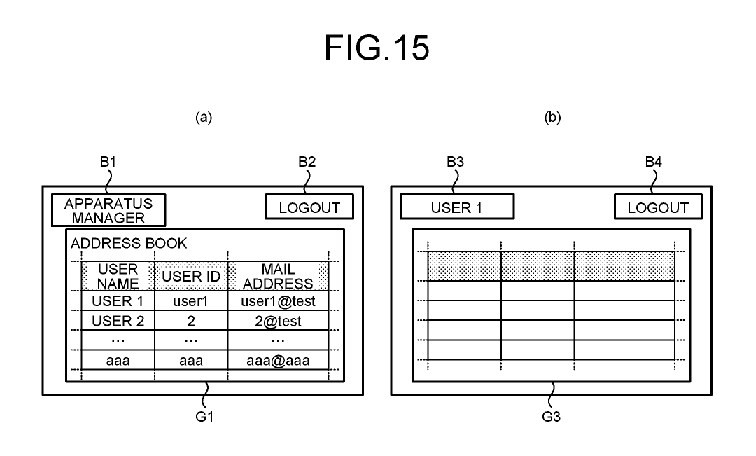

FIG. 15 is a diagram of exemplary displays of the display screen of the PC 200 and the display screen of the image processing apparatus 300 obtained when the display screen generator 401 performs the display restriction process for causing information not to be displayed or to be in a state equivalent to the state of not being displayed. FIG. 15 represents each of exemplary display screens that are obtained when the support person A performs an operation for displaying the address book from the PC 200 as in the exemplary displays of the first embodiment (see FIG. 1).

FIG. 15(a) is an exemplary display of the display screen of the PC 200 and matches the display illustrated in FIG. 11(a). FIG. 15(b) is an exemplary display of the display screen of the image processing apparatus 300 based on the screen information on which the display restriction process of causing information not to be displayed or to be in a state equivalent to the state of not being displayed has been performed. The display restriction process of causing information not to be displayed or to be in a state equivalent to the state of not being displayed causes the character information represented on the address book G1 in FIG. 15(a) not to be displayed, or visually not to be displayed, and causes the address book G1 to be displayed as an area G3 containing only ruled lines without character information. When information is caused no to be displayed visually, the background color is “white” in the example illustrated in FIG. 15(b) and accordingly the same “white” is set for the character color. Only the character information is exemplarily caused not to be displayed or not to be displayed visually herein. Alternatively, ruled lines, etc., may be caused not to be displayed or not to be displayed visually as appropriate.

### Fourth Embodiment

A fourth embodiment of the present invention represents a mode of an image processing system that causes the image processing apparatus 300 to display a screen that keeps concealing display information when there is a difference between “the authority information on the PC 200” and “the authority information on the image processing apparatus 300” in the authentication information during a remote connection in the first embodiment.

When there is the difference between the sets of authentication information, the display screen generator 401 (see FIG. 5) of the image processing apparatus 300 represented in the first embodiment acquires the display permissibility determination information and, on the basis of the information, performs the display restriction process on the screen information for the image processing apparatus. When there is the difference, the display screen generator according to the fourth embodiment (corresponding to the display screen generator 401) omits the process of checking the display permissibility determination information and keeps outputting a given screen as the screen information for the image processing apparatus to the second UI display unit 510 (see FIG. 5). In other words, the display permissibility determination information and the display permissibility determination information saving unit 403 are unnecessary. For example, each time the display screen generator according to the fourth embodiment outputs screen information to the remote screen transmitter 402 (see FIG. 5), the display screen generator sets given information for displaying an area in which information is displayed as blacked out with respect to a copy of the screen information. Alternatively, each time the display screen generator according to the fourth embodiment outputs screen information to the remote screen transmitter 402, the display screen generator reads given screen information that is stored in advance in the second storage unit and outputs the screen information to the second UI display unit 510. As the given screen information, one not containing display information not permitted to be displayed, such as screen information representing a background image, is output.

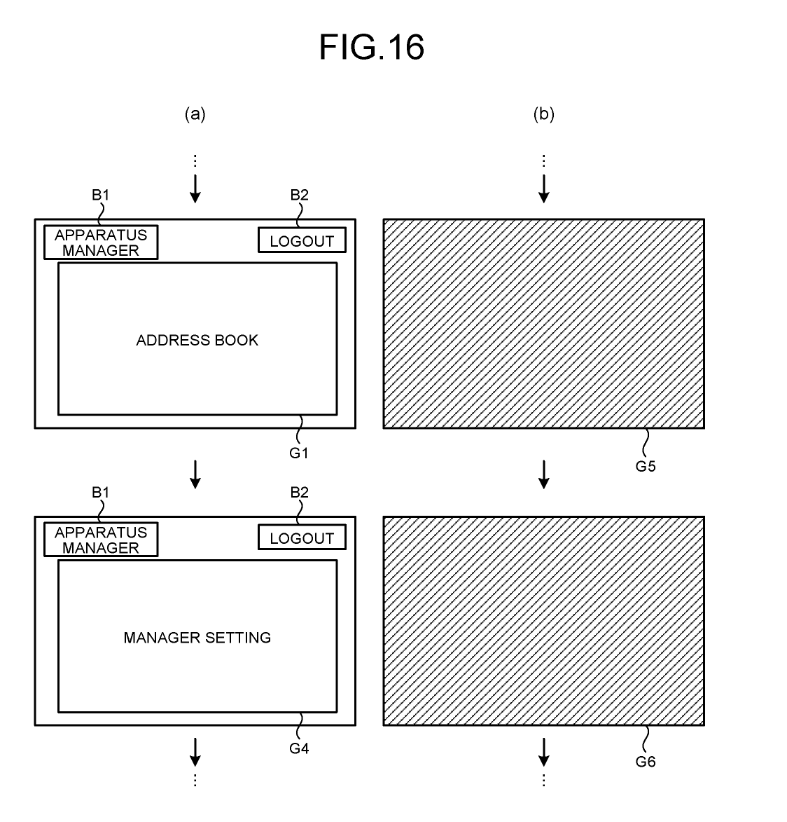

FIG. 16 is a diagram of exemplary displays of the display screen of the PC 200 and the display screen of the image processing apparatus 300 that are displayed on the basis of the screen information that is output by the display screen generator according to the fourth embodiment. These are exemplary displays of the respective display screen obtained when the support person A performs an operation of switching the screen from “address book” to “manager setting” from the PC 200.

FIG. 16(a) is an exemplary screen transition of the display screen of the PC 200, where the screen transitions from the upper one to the lower one. As illustrated in FIG. 16(a), the screen transitions from the screen displaying the address book G1 to the screen displaying the manager setting G4, where other screens are omitted.

FIG. 16(b) is displayed on the basis of the given screen information that is output by the display screen generator according to the fourth embodiment. The screens in FIG. 16(a) correspond to the screens in FIG. 16(b) respectively. In short, while the screen of the address book G1 is being displayed on the PC 200, a screen G5 is being displayed on the image processing apparatus of the fourth embodiment. Furthermore, once the screen is switched from the address book G1 to the manager setting G4 on the PC 200, the screen is switched from the screen G5 to the screen G6 on the image processing apparatus of the fourth embodiment. Both the screen G5 and the screen G6 illustrated in FIG. 16(b) are display screens on which the restriction process of concealing the address book G1 and the manager setting G4 illustrated in FIG. 16(a) on the basis of the given common screen information has been performed. Here, the state where the whole screen is displayed as blacked out is exemplified.

The display screen may be modified to another mode. For example, the display screen may be a screen colored in red, a pattern screen, or a screen containing a message.

As described above, the image processing system of the fourth embodiment includes the input device 25 and the first operation receiver 202 that serve as a first input unit for inputting first information, such as operation information. The image processing system further includes the operation panel 57 and the second operation receiver 514 that serve as a second input unit for also inputting second information, such as operation information. The image processing system further includes the LCD 24 and the first UI display unit 208 that serve as a first display unit that displays display information. The image processing system further includes the operation panel 57 and the second UI display unit 510 that serve as a second display unit that displays display information. The image processing system further includes the communication I/F 45, the operator determining unit 512, the authentication determining unit 405, and the authentication state saving unit 406 that serve as a login authentication processing unit that, when first authority information (authority information on, for example, an apparatus manager) for a login is input from the first input unit as the first information, performs authentication on the first authority information and performs a login process and, when second authority information for a login is input from the second input unit as the second information (authority information on, for example, a normal user), performs authentication on the second authority information and performs a login process. The image processing system further includes the display screen generator 401 serving as a determining unit that, when the first information is input from the first input unit, determines whether there is a difference between the first authority information and the second authority information on which authentication has been performed by the login authentication processing unit on the login process. The image processing system further includes the display screen generator 401, the communication I/F 45, the remote screen transmitter 402, the I/F 26, and the remote screen receiver 206 that serve as a display control unit that, when the determining unit determines that there is no difference between the first authority information and the second authority information, causes the first display unit and the second display unit to display common display information and, when the determining unit determines that there is the difference, causes the first display unit to display display information and causes the second display unit to keep restricting display of the display information.

As described above, in the fourth embodiment, because checking display permissibility determination information can be omitted, display permissibility determination information is unnecessary. Furthermore, because the process of generating a screen that is performed by the display screen generator is simplified, the process load of the CPU of the image processing apparatus on generation of a screen is reduced.

### Fifth Embodiment

A fifth embodiment of the present invention represents a case where, when display restriction is imposed on the screen of the image processing apparatus 300 or 301 of the first or second embodiment during a remote connection, message information representing the reason for the display restriction is incorporated in the screen. The screen containing the message information representing the reason for the display restriction according to the fifth embodiment is used in a way that, for example, message information representing the reason for the display restriction is set in the screen information on which the display is restricted on the image processing apparatus 300 or 301 of the first or second embodiment. For example, the display screen generator 401 or 410 sets, in the screen information having a setting for displaying part or all the display area of the display screen as blacked out, a part of the blacked out display area as a display area of information (such as an image) containing the above-described message that is previously created. The display screen generator 401 or 410 sets, in screen information in which information not permitted to be displayed is not displayed, information representing the above-descried message such that the message is displayed in a given area (for example, a blank area) of the display screen.

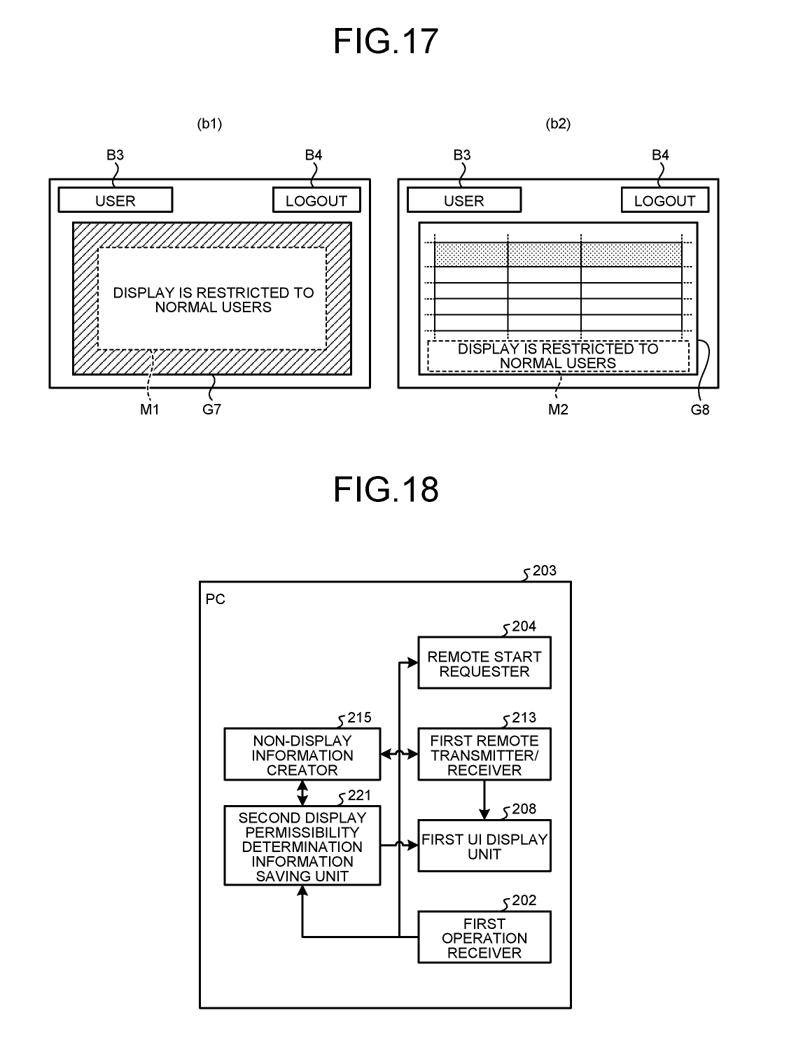

FIG. 17 is a diagram of exemplary displays of the display screen of the image processing apparatus (or the image processing apparatus 301) containing message information representing the reason for the display restriction that is output by the display screen generator according to the fifth embodiment. FIG. 17 exemplifies exemplary displays obtained when the support person A operates the “address book” from the PC 200 (or the PC 201).

FIG. 17 (b1) is an exemplary display on the image processing apparatus 300 (or the image processing apparatus 301) obtained when an image containing the above-described message is set in an area to be displayed as blacked out in the screen information. As illustrated in FIG. 17 (b1), a message M1 representing the reason for the display restriction is displayed in a part of an area G7 in which the display information of the “address book” is concealed.

FIG. 17 (b2) is an exemplary display on the image processing apparatus 300 (or the image processing apparatus 301) that is obtained when information representing the message is set in the screen information such that the message is displayed in a blank area. As illustrated in FIG. 17 (b2), a message M2 representing the reason for the display restriction is displayed in a blank area G8 of the “address book”.

As described above, in the fifth embodiment, when screen information on which a display restriction has been put is displayed on the image processing apparatus 300, message information representing the reason for the display restriction is incorporated in the screen information and displayed. Accordingly, even when information, such as characters, is not displayed on the display screen, the user B of the image processing apparatus 300 is able to know that display restriction is imposed on the screen information.

### Sixth Embodiment

A sixth embodiment of the present invention represents a mode of a PC that enables a change of a setting of the display permissibility determination information that is stored in the first storage unit of the PC 201 of the second embodiment.

FIG. 18 is a diagram of an exemplary functional block of a PC according to the sixth embodiment. A PC 203 illustrated in FIG. 18 is obtained by replacing the display permissibility determination information saving unit 211 in the PC 201 according to the second embodiment (see FIG. 12) with a second display permissibility determination information saving unit 221. The second display permissibility determination information saving unit 221 will be described below as an aspect different from that of the second embodiment.

As the display permissibility determination information saving unit 211 of the second embodiment (see FIG. 12) does, the second display permissibility determination information saving unit 221 saves display permissibility determination information in a first storage unit of the PC 203 and, in accordance with an instruction from the non-display information creator 215, extracts setting information of the display permissibility determination information.

In the sixth embodiment, the second display permissibility determination information saving unit 221 further has a function serving as a setting unit that sets setting information of the display permissibility determination information. The second display permissibility determination information saving unit 221 reads the setting information of the display permissibility determination information in the first storage unit and outputs the setting information to the first UI display unit 208 or sets setting change information that is accepted by the first operation receiver 202 to the display permissibility determination information in the first storage unit.

Specifically, when the first operation receiver 202 accepts an operation input for calling the setting of the display permissibility determination information from the support person A, the first operation receiver 202 instructs the second display permissibility determination information saving unit 221 to read the setting information. The second display permissibility determination information saving unit 221 then reads the setting information of the display permissibility determination information in the first storage unit and, for example, arranges the setting information on a given setting screen and outputs the setting screen to the first UI display unit 208. The support person A operates the setting screen that is displayed on the screen of the PC 203 and inputs the setting information to register or change the setting information. The first operation receiver 202 accepts the setting data after the registration or change on the setting screen together with a setting instruction command and instructs the second display permissibility determination information saving unit 221 to set the setting information. The display permissibility determination information saving unit 221 rewrites and updates the setting of the display permissibility determination information in the first storage unit with the setting information that is accepted by the first operation receiver 202.

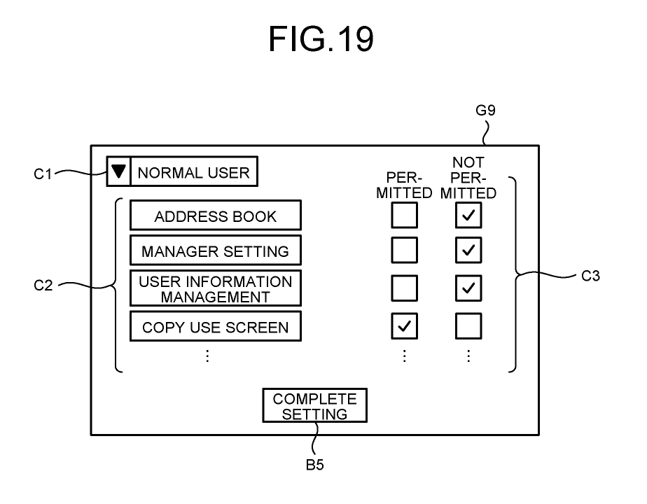

FIG. 19 is a diagram of an example of the above-described setting screen. A setting screen G9 exemplified in FIG. 19 corresponds to the display permissibility determination information D1 represented in the first embodiment (see FIG. 6). The setting screen G9 has a an authority box C1 for selecting/registering the type of authority, an item box C2 for displaying/inputting display items, a specifying box C3 for specifying whether to permit display of display items, and a setting completion button B5 for issuing an instruction for completing the setting.

The support person A specifies “normal user” or “apparatus manager” in the authority box C1 on the setting screen G9. On the basis of the setting information of the display permissibility determination information, items are displayed in the item box C2 and setting information “permitted” or “not permitted” corresponding to the specified authority is displayed in the specifying box C3. The boxes in FIG. 19 represent various types of information represented when the support person A specifies “normal user” in the authority box C1. The check in the specifying box C3 represents the setting state of the corresponding display items in the item box C2. The support person A switches the specifying between “permitted” and “not permitted”, adds or delete an item, or add or delete authority on the setting screen G9. Upon finishing the setting, the support person A presses the setting completion button B5. Accordingly, the first operation receiver 202 accepts a setting instruction command with respect to the setting information that is set on the setting screen G9.

The mode has been represented that enables a change in the setting of the display permissibility determination information that is stored in the PC 201 of the second embodiment. Alternatively, a modification may be made in which it is possible to change the setting of the display permissibility determination information that is stored in the image processing apparatus 300 of the first embodiment.

For example, the display permissibility determination information saving unit 403 of the image processing apparatus 300 may be provided with a function serving as the setting unit. In this case, the second operation receiver 514 accepts an operation input for calling the setting of the display permissibility determination information from the user B and instructs the display permissibility determination information saving unit 403 to read the setting information. Then the display permissibility determination information saving unit 403 reads the setting information of the display permissibility determination information in the second storage unit and, for example, arranges the setting information on a given setting screen and outputs the setting screen to the second UI display unit 510. The user B operates the setting screen displayed on the screen of the image processing apparatus 300 and inputs the setting information to register or change the setting information. The second operation receiver 514 accepts the setting data after the registration or change together with a setting instruction command and instructs the display permissibility determination information saving unit 403 to set the setting information. Then the display permissibility determination information saving unit 403 rewrites and updates the setting of the display permissibility determination information in the second storage unit with the setting information that is accepted by the second operation receiver 514.

Furthermore, the PC 200 may be provided with, as part of the function of the setting unit, for example, a function of acquiring setting information from the image processing apparatus 300 and an updating function of updating the display permissibility determination information in the image processing apparatus 300 with the setting information that is input on the PC 200. In this case, in accordance with an instruction from the PC 200, the image processing apparatus 300 reads the setting information of the display permissibility determination information, sends the setting information to the PC 200, and performs a process of updating the setting of the display permissibility determination information by rewriting it with the setting information that is transmitted from the PC 200.

As described above, in the sixth embodiment, the setting unit serving as a setting unit is provided, which enables the support person A or the user B to set the setting information of the display permissibility determination information on the screen. Accordingly, the support person A or the user B is able to change the item not permitted to be displayed as appropriate.

In the configuration enabling the support A to set the display permissibility determination information on the screen of the PC 200, the support A is able to remove a display restriction on the screen of the image processing apparatus 300 as appropriate during a remote operation. During a remote operation, the support person A remotely operates the image processing apparatus 300 while giving an operational instruction to the mobile phone 600 of the user B. During the remote operation, information may be not displayed on the screen of the image processing apparatus 300 because of the setting of the display permissibility determination information. Upon accepting a request for displaying part or all the information from the user B, the support person A changes the setting of the display permissibility determination information from “not permitted” to “permitted” as appropriate on the PC 200 to remove the restriction on part of all the display on the screen of the image processing apparatus 300.

### Seventh Embodiment

A seventh embodiment of the present invention represents a mode of an image processing system where, when the PC 200 or 201 of the first or second embodiment requests the image processing apparatus 300 or 301 to change the authority during a remote connection, the image processing apparatus 300 or 301 displays a check screen on the image processing apparatus. An example based on the first embodiment will be described below.

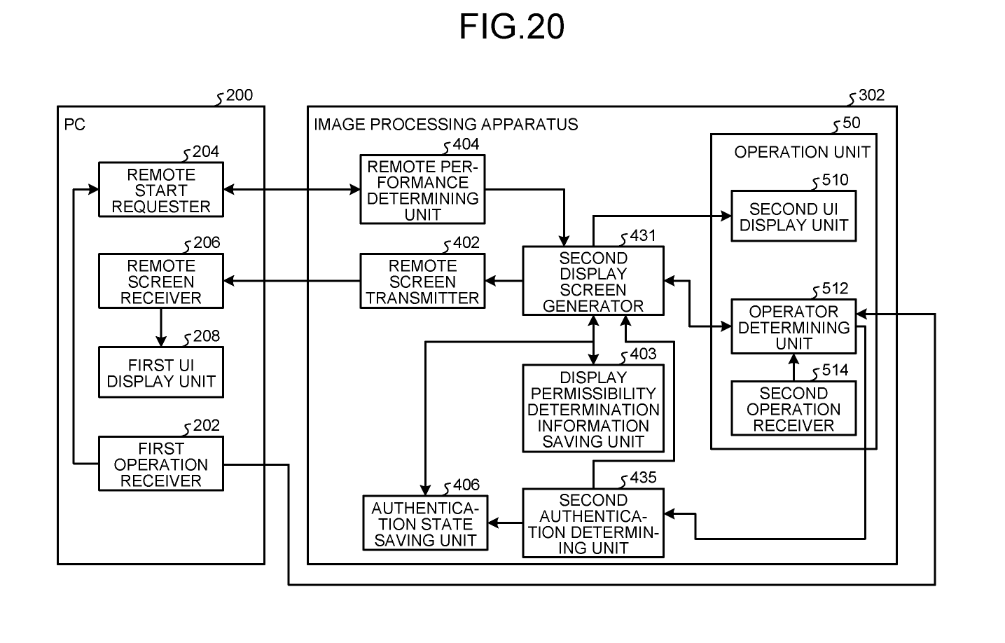

FIG. 20 is a diagram of an exemplary functional block of the image processing system according to the seventh embodiment. The functional block diagram is obtained by replacing the display screen generator 401 and the authentication determining unit 405 in the functional block diagram of the first embodiment (see FIG. 5) with a second display screen generator 431 and a second authentication determining unit 435 that further have a function serving as a checking unit. The second display screen generator 431 and the second authentication determining unit 435 of an image processing apparatus 302 will be described mainly below.

The second authentication determining unit 435 has, in addition to the function of authentication determining unit 405 represented in the first embodiment, part of the function of the checking unit. The second display screen generator 431 has, in addition to the function of the display screen generator 401 represented in the first embodiment, the remaining function of the checking unit.

The function of the checking unit is a function of checking, with the user B of the image processing apparatus 302, whether to accept a request for changing the authority and logging in the image processing apparatus 302 again from the PC 200. Specifically, when authentication is established with respect to the login information on a subject with authority to which the authority is to be changed, the second authentication determining unit 435 suspends the authority information on the subject with authority to which the authority is to be changed from being output to the authentication state saving unit 406 and issues a notification for causing the second display screen generator 431 to check whether to change the authority. The second display screen generator 431 reads the check screen information from the second storage unit in response to the notification and outputs the check screen information incorporating the authority information on the subject with authority to which the authority is to be changed to the second UI display unit 510. The second authentication determining unit 435 receives operation information representing which of “permit” and “reject” is selected on the check screen by the user B from the operator determining unit 512. In order to allow the user B to select and input “permit” or “reject”, the operator determining unit 512 removes the restriction on receiving inputs from the second operation receiver 514. The operator determining unit 512 then notifies the second authentication determining unit 435 of the operation information.

When the notification represents “permit”, the second authentication determining unit 435 determines “to change the authority”. In that case, the second authentication determining unit 435 outputs the authority information on the subject with authority to which the authority is to be changed, which is the authority information suspended from being output, to the authentication state saving unit 406. The second authentication determining unit 435 then notifies the second display screen generator 431 of information representing that authentication is established. In response to the notification, the second display screen generator 431 generates sets of screen information respectively for the PC 200 and the image processing apparatus 302 as the display screen generator 401 of the first embodiment does.

When the notification from the operator determining unit 512 represents “reject”, the second authentication determining unit 435 determines “not to change the authority” and discards the authority information on the subject with authority to which the authority is to be changed, which is the authority information suspended from being output. The second authentication determining unit 435 then notifies the second display screen generator 431 of information representing that changing the authority is rejected. In response to the notification, the second display screen generator 431, for example, outputs screen information representing that changing the authority is rejected as the display screen for the PC 200 and the image processing apparatus 302. Accordingly, the support person A of the PC 200 is able to confirm that changing the authority is rejected by the image processing apparatus 302.

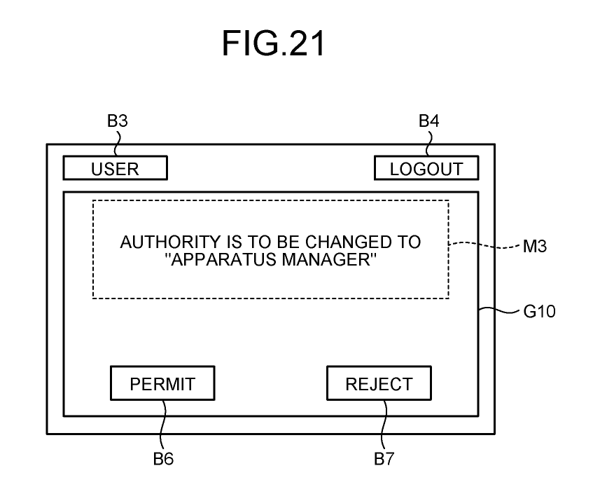

FIG. 21 is a diagram of an example of the check screen that is displayed on the screen of the image processing apparatus 302. A check screen G10 illustrated in FIG. 21 contains an authority change check message M3, a permission button B6, and a rejection button B7. The user B checks the authority information of the subject with authority to which the authority is to be changed according to the check message M3 and, to permit changing the authority, presses the permission button B6. On the other hand, the user B presses the permission button B7 to reject changing the authority.

As described above, in the seventh embodiment, the checking unit serving as a checking unit is provided and, when the authority is changed by performing a remote operation, the check screen for allowing the user B of the image processing apparatus 302 to choose whether to give a permission is displayed. This makes it possible to change the authority by which the image processing apparatus 302 is being logged in under the consent between the support person A and the user B.

### Eighth Embodiment

An authority recovery process of an eighth embodiment of the present invention will be described, which is a process performed by the image processing apparatus 300 or 301 of the first or second embodiment when a communication with the PC 200 or 201 is disconnected due to a communication error during a remote connection. The authority recovery process based on the first embodiment will be exemplified below.

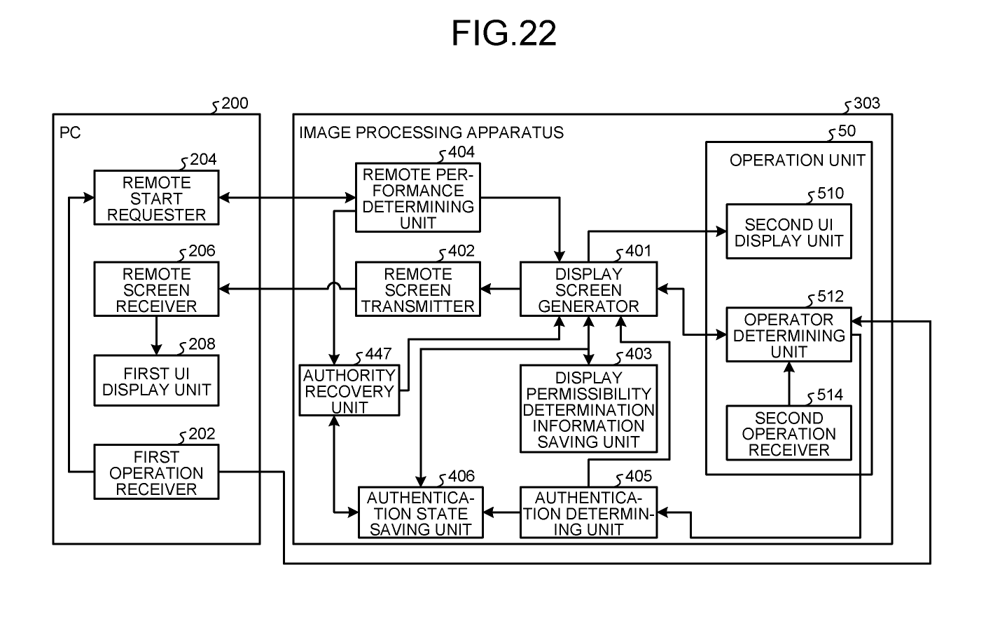

FIG. 22 is a diagram of an exemplary functional block of an image processing system according to the eighth embodiment. The functional block diagram is obtained by adding an authority recovery unit 447 to the functional block diagram (see FIG. 5) of the first embodiment. The authority recovery unit 447 of an image processing apparatus 303 and the functional unit corresponding to authority recovery will be described below.

As represented in the first embodiment, the remote performance determining unit 404 manages the state of a remote connection with an external device. When an error in communication with the PC 200, such as a communication failure, occurs after a remote connection with the PC 200 is established, the remote performance determining unit 404 disconnects the communication with the PC 200. Once the communication with the PC 200 is disconnected, the remote performance determining unit 404 notifies the authority recovery unit 447 of the disconnection.

In response to the notification from the remote performance determining unit 404, the authority recovery unit 447 acquires authentication information in the second storage unit from the authentication state saving unit 406. When there is a difference between “the authority information on the image processing apparatus” and “the authority information on the PC” according to the acquired authentication information, the authority recovery unit 447 executes a process of recovering the authority on the login to “the authority information on the image processing apparatus”. For example, assume that a notification indicating a communication disconnection is issued after the support person A changes the authority from that of “normal user” to that of “apparatus manger”. In that case, the authority recovery unit 447 executes a process of recovering the authority from that of “apparatus manger” to that of “normal user”. In that process, the authority recovery unit 447 instructs the display screen generator 401 to generate screen information corresponding to “normal user”.

In response to the instruction, the display screen generator 401 acquires given screen information (for example, top screen information) corresponding to “normal user” from the second storage unit and outputs the screen information to the second UI display unit 510 without putting any display restriction on the screen information. Furthermore, in response to the instruction from the authority recovery unit 447, the display screen generator 401 notifies the operator determining unit 512 of the end of the remote connection. Accordingly, the setting of the operator determining unit 512 to reject to receive operation information from the second operation receiver 514 is canceled. Accordingly, after the recovery of authority, the operation screen for “normal user” without any display restriction is displayed on the screen of the image processing apparatus 303 and the operator determining unit 512 is able to receive a touch operation performed by the user B on the operation screen via the second operation receiver 514. Thereafter, the image processing apparatus 303 runs according to the process performed when the second operation receiver 514 accepts operation information.

When there is no difference between “the authority information on the image processing apparatus” and “the authority information on the PC”, the authority recovery unit 447 notifies the operator determining unit 512 of the end of the remote connection via the display screen generator 410. Accordingly, the user B is able to operate the operation screen displayed on the screen of the image processing apparatus 303 and thus continue operating the image processing apparatus 303.

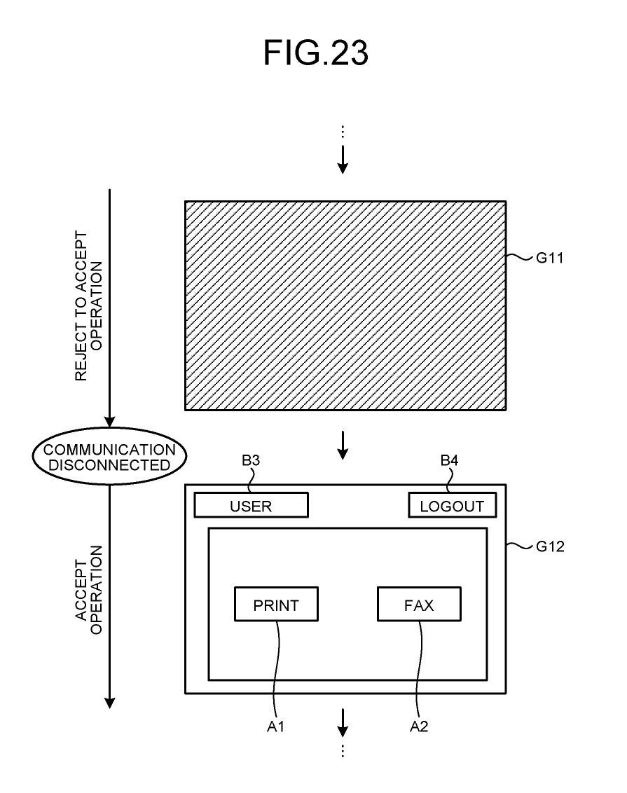

FIG. 23 is a diagram of an exemplary screen transition of the display screen of the image processing apparatus 303 that occurs when an error occurs in a communication with the PC 200. The case where a communication error occurs when the support person A operates “address book” from the PC 200 is exemplified here to represent the transition of the screen of the image processing apparatus 303. The screen transitions from the upper one to the lower one in FIG. 23.

A screen G11 illustrated in FIG. 23 represents the screen of the image processing apparatus 303 displayed when the support person A is operating the address book by performing a remote operation, i.e., the screen on which the display restriction is imposed. A screen G12 represents the screen displayed after the authority is recovered to the original authority of “normal user” because of disconnection of a communication. An operation setting screen for printing or FAX that is displayed as an exemplary top screen for “normal user” is represented in a simplified manner here. In an operation setting area A1 for printing and an operation setting area A2 for FAX that are contained in the screen G12, various setting buttons and execution buttons are displayed such that inputs can be made. In this manner, even when a communication is disconnected due to, for example, occurrence of a communication error during a remote operation, the screen corresponding to the recovered original authority of “normal user” is displayed on the screen of the image processing apparatus 303 such that inputs can be made as illustrated in FIG. 23.

As described above, the authority recovery unit 447 serving as an authority recovery unit is provided in the eighth embodiment. Accordingly, even after a remote communication is disconnected due to a communication error, the user B is able to continue operating the image processing apparatus 303 on behalf of the support person A.

### Ninth Embodiment

A display restriction process of an eight embodiment of the present invention will be described, which is a process performed by the image processing apparatus 300 or 301 when a communication with the PC 200 or 201 is disconnected during a remote connection. The display restriction process based on the first embodiment will be exemplified below.

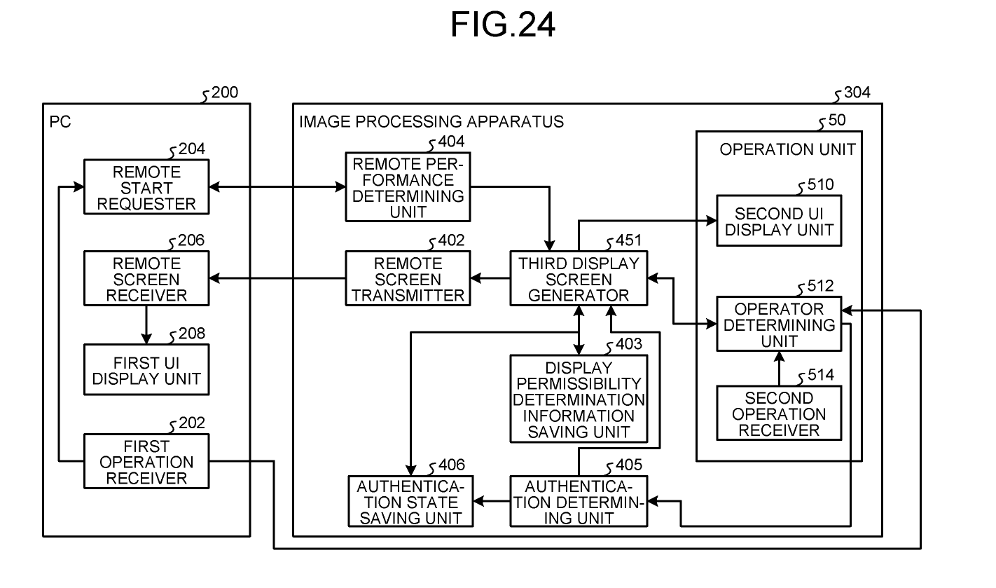

FIG. 24 is a diagram of an exemplary functional block of an image processing system according to the ninth embodiment. The functional block diagram is obtained by replacing the display screen generator 401 in the functional block diagram (see FIG. 5) of the first embodiment with a third display screen generator 451.

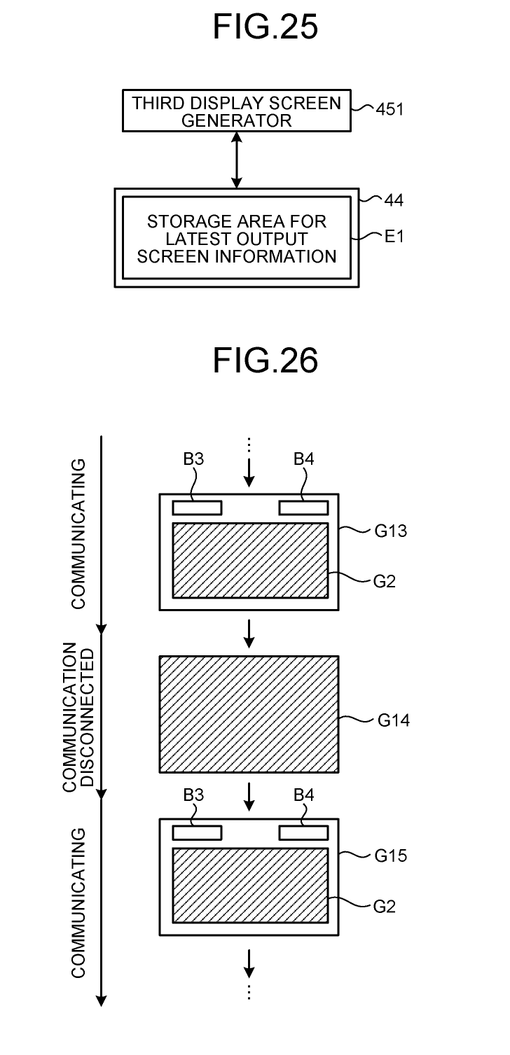

FIG. 25 is a diagram of part of the setting in the second storage unit 2 (the HDD 44 is exemplified herein) accessed by the third display screen generator 451. The third display screen generator 451 of an image processing apparatus 304 of the ninth embodiment and the functional unit corresponding to the display restriction process will be described below with reference to FIGS. 24 and 25.

As described with respect to the eighth embodiment, when an error in communication with the PC 200 occurs after a remote connection with the PC 200 is established, the remote performance determining unit 404 disconnects the communication with the PC 200. In the ninth embodiment, after the disconnection of the communication, the remote performance determining unit 404 notifies the third display screen generator 451 of the disconnection.

The third display screen generator 451 saves the screen information that is most recently output to the second UI display unit 510 in an area E1 (see FIG. 25) for storing the screen information most recently output in a given area of the second storage unit, specifically, in the HDD 44 in this example, by, for example, rewriting the screen information previously stored. When the above-described notification is issued, the third display screen generator 451 outputs screen information (replacement screen) (not illustrated) for communication error that is stored in the second storage unit in advance to the second UI display unit 510.

The screen information for communication error is not regarded as the output screen information most recently output to be stored in the storage area E1 for a rewrite and an update. The screen for communication error may be, for example, screen information for displaying the whole screen as blacked out or a message screen representing a communication error.

Upon receiving a notification representing a re-connection of communication from the remote performance determining unit 404 after the disconnection of the communication due to a trouble, such as a communication error, the third display screen generator 451 outputs the latest screen information in the storage area E1 to the second UI display unit 510. In short, the third display screen generator 451 outputs the screen information before the display of the screen for communication error to the second UI display unit 510 again.

Other aspects of the function is same as those of the display screen generator 401 represented in the first embodiment and therefore descriptions thereof will be omitted.

FIG. 26 is a diagram of an exemplary screen transition of the display screen of the image processing apparatus 304 that occurs when an error occurs in a communication with the PC 200. The case where a communication error occurs when the support person A operates “address book” from the PC 200 is exemplified here to represent the transition of the screen of the image processing apparatus 304. The screen transitions from the upper one to the lower one in FIG. 26.

A screen G13 illustrated in FIG. 26 represents the screen of the image processing apparatus 304 displayed when the support person A is operating the address book by performing a remote operation (the same screen as that of the address book G11 in FIG. 23), i.e., the screen on which the display restriction is imposed. A screen G14 represents the screen of the image processing apparatus 304 displayed after the remote connection is disconnected due to a trouble, i.e., the screen for communication error. A screen that is blacked out is exemplified as the screen for communication error. A screen G15 represents the screen of the image processing apparatus 304 after the recovery of the remote communication (the same screen as the screen G13).

As described above, in the ninth embodiment, when a communication is disconnected due to a communication error during a remote operation, the screen for communication error is displayed on the screen of the image processing apparatus 304 and the user B is kept waiting until the communication is recovered. Once the communication is recovered, the screen is returned to the screen before the communication error to allow the user B to continue receiving the support from the support person A depending on a remote operation.

### Tenth Embodiment

A modification of the process of generating information for concealing a non-display area, which is the process performed by the non-display information creator 215 of the PC 201 represented in the second embodiment, will be described as a tenth embodiment of the present invention.

First of all, a process of generating coordinate information will be described as one mode. As described with respect to the second embodiment, the non-display information creator 215 specifies an area not permitted to view in a copy of screen information received by the first remote information transmitter/receiver 213. In the process of generating coordinate information, the non-display information creator 215 reads coordinate information on an area in which the specified area not permitted to view is displayed. For example, when the area is a quadrilateral, the non-display information creator 215 generates the X and Y coordinates of each of the vertices as coordinate information. In the image processing apparatus 301, the display screen generator 410 sets an area in which the display information is concealed in the screen information and sets the luminance brightness of the area at 0 or makes a setting for not displaying the display information, such as character information, contained in the area.

The process of generating a partial image having a display size will be described as another mode. In the process of generating a partial image having a display size, the non-display information creator 215 reads the area in which a specified area not permitted to view is displayed and generates a partial image having the size of the area. For example, when the image is displayed as blacked out, an image in which the luminance brightness of the pixels over the area is 0 is generated. In the image processing apparatus, the display screen generator 410 sets screen information such that the generated image is displayed on the display information area on the display screen.

A process of generating screen information will be described as a still another mode. This process is a process performed by the PC 201, which is also the process performed by the display screen generator 410 of the image processing apparatus 301. In the generation process, the non-display information creator 215 of the PC 201 specifies an area not permitted to view from the screen information and performs the display restriction process on the screen information. The non-display information creator 215 then transmits the screen information on which the display restriction process has been performed to the image processing apparatus 301. In the image processing apparatus, the display screen generator 410 outputs the screen information to the second UI display unit 510.

In the respective embodiments described above, the programs to be executed are stored in a storage unit such as a ROM, but is not limited thereto. Each program may be stored in a computer-readable storage medium, which may be provided as a computer program product. For example, the program may be provided as a file(s) in an installable form or executable form, stored in a storage medium such as flexible disk, CD-R, digital versatile Disk (DVD), Blu-ray Disc (registered trademark), or semiconductor memory.

The programs that are executed in the respective embodiments may be stored in a computer connected to a network, such as the Internet, and may be configured to be downloaded via the network and provided. The programs that are executed in each of the embodiments may be configured to be provided or distributed via a network, such as the Internet.

The functions of the units represented in the above-described embodiments are implemented by the CPU by executing the various programs. Alternatively, part or all the functions may be implemented in other modes. For example, part of all the functions of the image processing apparatus may be implemented with a dedicated hardware circuit (such as an ASIC).

According to the embodiments, there is an effect that, even when a support person change the authority of a user of an information processing apparatus, such as an MFP, while remotely operating the information processing apparatus, it is possible to prevent information that the user does not have authority to view from being viewed on the screen of the information processing apparatus.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
a first input unit for inputting first information;
a second input unit for inputting second information;
a first display unit;
a second display unit;
a login authentication processing unit configured to,
when first authority information for a login is input from the first input unit as the first information, perform authentication on the first authority information and performs a login process, and
when second authority information for a login is input from the second input unit as the second information, perform authentication on the second authority information and performs a login process;
a determining unit configured to, when the first information is input from the first input unit, determine whether there is a difference between the first authority information and the second authority information on which authentication has been performed by the login authentication processing unit on the login process; and
a display control unit configured to,
when the determining unit determines that there is no difference between the first authority information and the second authority information, cause the first display unit and the second display unit to display common display information, and
when the determining unit determines that there is the difference, cause the first display unit to display display information and causes the second display unit to restrict displaying of content of the display information.

2. The information processing system according to claim 1, further comprising a storage unit configured to store permissibility information with respect to each set of authority information representing whether to display the display information, wherein
the display control unit, when the determining unit determines that there is the difference, determines the content to be restricted based on the permissibility information stored in the storage unit.

3. The information processing system according to claim 2, wherein the second display unit displays the content to be restricted as blacked out or in another image.

4. The information processing system according to claim 2, wherein the second display unit does not substantially display the content to be restricted.

5. The information processing system according to claim 1, wherein the display control unit causes any one of the first display unit and the second display unit that is caused to restrict displaying of content of the display information to display information representing a reason of the restriction.

6. The information processing system according to claim 1, further comprising a setting unit configured to set the permissibility information stored in the storage unit or change the setting.

7. The information processing system according to claim 1, further comprising a checking unit configured to, when the first authority information is input to change the authority for a login from the first input unit after the login authentication processing unit performs authentication on the second authority information in response to the input of the second authority information from the second input unit, request a user who inputs the second authority information to permit to change the authority.

8. The information processing system according to claim 1, further comprising an information processing apparatus remotely connected to an apparatus that includes the second input unit and the second display unit via a communication line, the information processing apparatus including the first input unit and the first display unit.

9. The information processing system according to claim 1, further comprising:
a first apparatus including the first input unit and the first display unit; and
a second apparatus connected to the second apparatus, the second apparatus including the second input unit and the second display unit, wherein
the login authentication processing unit, the determining unit, and the display control unit are each included in the first apparatus or the second apparatus such that the units are distributed.

10. An information processing apparatus comprising:
a second input unit for inputting second information;
a transmitter configured to transmit display information to a remote apparatus that remotely operates the information processing apparatus;
a second display unit configured to display the display information;
a storage unit configured to store permissibility information with respect to each set of authority information representing whether to display the display information;
a login authentication processing unit configured to,
when first authority information for a login is input from the remote apparatus as first information, perform authentication on the first authority information and performs a login process, and
when second authority information for a login is input from the second input unit as the second information, perform authentication on the second authority information and perform a login process;
a determining unit configured to, when the first information is input from the remote apparatus, determine whether there is a difference between the first authority information and the second authority information on which authentication has been performed by the login authentication processing unit on the login process; and
a first display control unit configured to,
when the determining unit determines that there is no difference between the first authority information and the second authority information, cause the transmitter to transmit display information and causes the second display unit to display display information common with the display information, and
when the determining unit determines that there is the difference, impose a restriction on display of at least display information common with the display information that the transmitter is caused to display, which is the display performed by the second display unit, based on the permissibility information in the storage unit.

11. The information processing apparatus according to claim 10, wherein the second display unit displays the display information on which the restriction is imposed in its display as blacked out or in another image.

12. The information processing apparatus according to claim 10, wherein the first display control unit causes the second display unit that is caused to restrict display of the display information to display information representing a reason of the restriction on the display.

13. The information processing apparatus according to claim 10, further comprising an authority recovery unit configured to, when a communication with the remote apparatus is disconnected, recover the authority for a login to authority that is used for the latest login on the image processing apparatus.

14. The information processing apparatus according to claim 10, wherein, when a communication with the remote apparatus is disconnected due to a communication error, the first display control unit causes the second display unit to display a replacement screen.

15. An information processing apparatus comprising:
a first input unit for inputting first information;
a first display unit that displays display information;
an input information transmitter configured to transmit the first information that is input by the first input unit to another information processing apparatus to be remotely operated;
a receiver configured to receive a creation-requesting request with respect to the display information and display restriction information that the first display unit is caused to display;
a storage unit configured to store, with respect to each set of authority information, permissibility information representing whether to display the display information on the other information processing apparatus to be remotely operated;
a creator configured to, when the receiver receives the creation-requesting request, create display restriction information that restricts display of the display information on the other information processing apparatus to be remotely operated based on the permissibility information stored in the storage unit; and
a restriction information transmitter configured to transmit the display restriction information that is created by the creator to the other information processing apparatus to be remotely operated.

16. The information processing apparatus according to claim 15, wherein the display restriction information is coordinate information representing a display area of the display information to be restricted.

17. The information processing apparatus according to claim 15, wherein the display restriction information is a partial image having a size that conceals the display information to be restricted.

18. The information processing apparatus according to claim 15, wherein the display restriction information is screen information that the information processing apparatus to be remotely operated obtains by performing a display restriction process of concealing the display information to be restricted.

19. The information processing apparatus according to claim 15, further comprising a setting unit configured to change a setting of the permissibility information with respect to each set of authority information.
